(19) United States
(12) Patent Application Publication
(10) Pub. No.: US 2019/0329748 A1
(43) Pub. Date: Oct. 31, 2019

(54) Hydraulic Control Apparatus and Brake System

(71) Applicant: Hitachi Automotive Systems, Ltd., Hitachinaka-shi, Ibaraki (JP)

(72) Inventors: Takahiro KAWAKAMI, Atsugi-shi, Kanagawa (JP); Ryohei MARUO, Kawasaki-shi, Kanagawa (JP); Chiharu NAKAZAWA, Kawasaki-shi, Kanagawa (JP)

(21) Appl. No.: 16/310,189

(22) PCT Filed: Jun. 15, 2017
(86) PCT No.: PCT/JP2017/022113

§ 371 Date: Dec. 14, 2018

(30) Foreign Application Priority Data
Jun. 17, 2016 (JP) 2016-120920

(51) Int. Cl. B60T 13/16; B60T 8/40; B60T 13/62

(52) U.S. Cl. CPC B60T 13/161; B60T 8/409; B60T 2270/82; B60T 2270/402; B60T 2270/404; B60T 13/62

(57) ABSTRACT

An object of the present invention is to provide a hydraulic control apparatus capable of layout flexibility. A hydraulics control apparatus includes a second unit (a hydraulic unit) and a first unit (a stroke simulator unit). The second unit includes a housing including a brake fluid passage therein, a positive pressure fluid passage and a back-pressure fluid passage (a unit connection fluid passage) each having one end side connected to the brake fluid passage, a positive pressure port and a back-pressure port (a unit connection port) provided on a surface of the housing and connected to the other end sides of the positive pressure fluid passage and the back-pressure fluid passage, a pump (a hydraulic source) provided inside the housing and configured to generate a hydraulic pressure in each of wheel cylinders of a vehicle via the brake fluid passage, and a motor attached to a surface of the housing and configured to actuate the pump. The first unit includes a stroke simulator. The stroke simulator is configured to generate a reaction force of the brake pedal operation. The first unit further includes a first connection fluid passage and a second connection fluid passage (a simulator connection fluid passage) each having one end side connected to the stroke simulator, and a simulator first connection port and a simulator second connection port (a simulator connection port).

### TECHNICAL FIELD

The present invention relates to a hydraulic control apparatus and a brake system.

### BACKGROUND ART

As this kind of technique, there is disclosed a technique discussed in the following patent literature, PTL 1. PTL 1 discloses a hydraulic control apparatus including a stroke simulator.

### CITATION LIST

### Patent Literature

[PTL 1] Japanese Patent Application Public Disclosure No. 2007-022351

### SUMMARY OF INVENTION

### Technical Problem

One of objects of the present invention is to provide a hydraulic control apparatus and a brake system capable of improving layout flexibility.

### Solution to Problem

In a hydraulic control apparatus according to one aspect of the present invention, a unit including a stroke simulator is provided with a fluid passage connected to the stroke simulator.

Therefore, according to the one aspect of the present invention, the layout flexibility can be improved.

### BRIEF DESCRIPTION OF DRAWINGS

FIG. 1 is a perspective view of a part of a brake system according to a first embodiment.

FIG. 2 illustrates a schematic configuration of the brake system according to the first embodiment.

FIG. 3 is an exploded perspective view of a first unit according to the first embodiment.

FIG. 4 is a perspective view of a second unit with the first unit attached thereto according to the first embodiment.

FIG. 5 is a front view of the second unit with the first unit attached thereto according to the first embodiment.

FIG. 6 is a back view of the second unit with the first unit attached thereto according to the first embodiment.

FIG. 7 is a top view of the second unit with the first unit attached thereto according to the first embodiment.

FIG. 8 is a bottom view of the second unit with the first unit attached thereto according to the first embodiment.

FIG. 9 is a left side view of the second unit with the first unit attached thereto according to the first embodiment.

FIG. 10 is a right side view of the second unit with the first unit attached thereto according to the first embodiment.

FIG. 11 is a cross-sectional view taken along a line A-A illustrated in FIG. 10.

FIG. 12 is a cross-sectional view taken along a line B-B illustrated in FIG. 10.

FIG. 13 is a right side view of an outer appearance of the second unit according to the first embodiment as viewed from an X-axis positive direction side.

FIG. 14 is a left side view of an outer appearance of the first unit according to the first embodiment as viewed from an X-axis negative direction side.

FIG. 15 is a perspective view of the second unit with the first unit attached thereto according to a second embodiment.

FIG. 16 is a front view of the second unit with the first unit attached thereto according to the second embodiment.

FIG. 17 is a back view of the second unit with the first unit attached thereto according to the second embodiment.

FIG. 18 is a top view of the second unit with the first unit attached thereto according to the second embodiment.

FIG. 19 is a bottom view of the second unit with the first unit attached thereto according to the second embodiment.

FIG. 20 is a left side view of the second unit with the first unit attached thereto according to the second embodiment.

FIG. 21 is a right side view of the second unit with the first unit attached thereto according to the second embodiment.

FIG. 22 is a cross-sectional view taken along a line C-C illustrated in FIG. 16.

FIG. 23 is a cross-sectional view taken along a line D-D illustrated in FIG. 16.

FIG. 24 is a right side view of the outer appearance of the second unit according to the first embodiment as viewed from a Y-axis positive direction side.

FIG. 25 is a left side view of the outer appearance of the first unit according to the first embodiment as viewed from a Y-axis negative direction side.

### DESCRIPTION OF EMBODIMENTS

In the following description, embodiments for implementing the present invention will be described with reference to the drawings.

### First Embodiment

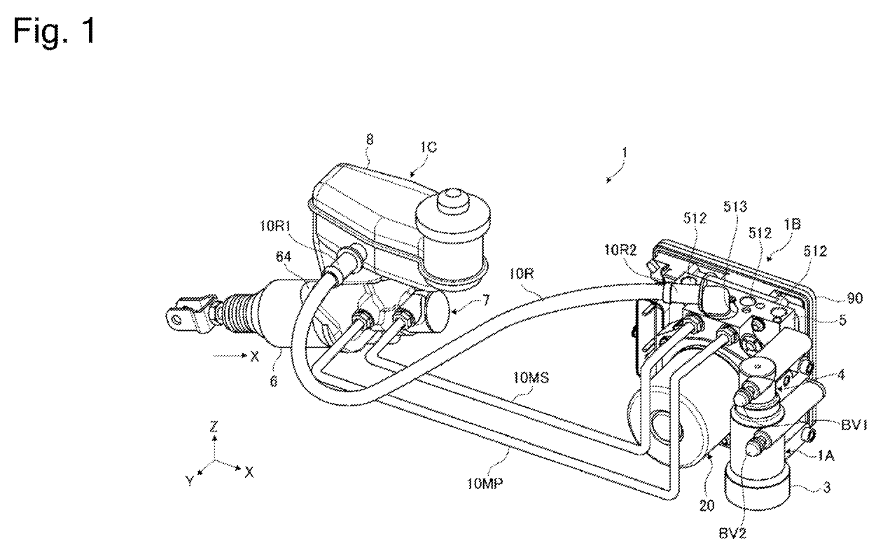

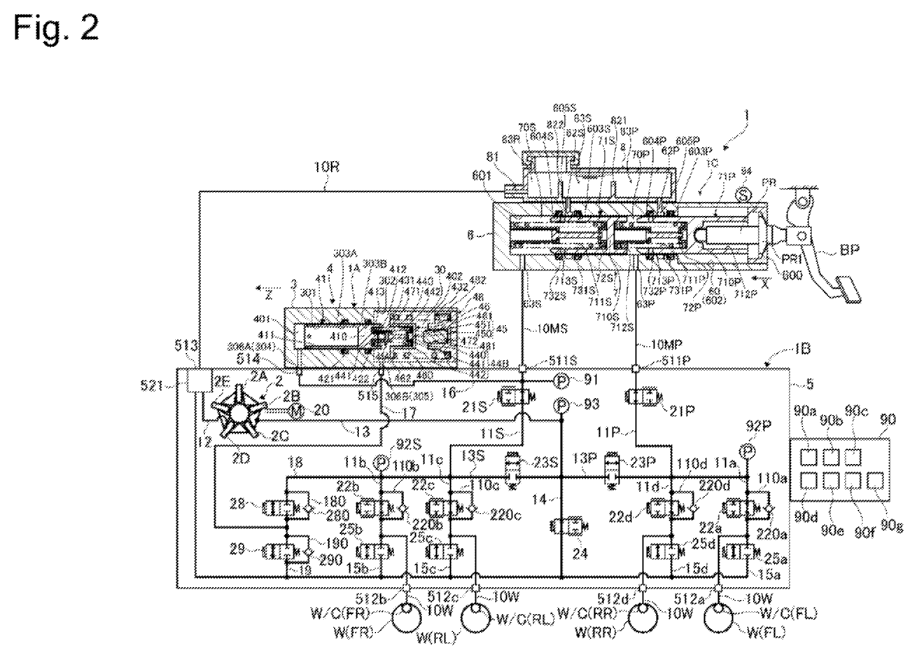

First, a configuration will be described. FIG. 1 illustrates an outer appearance of a part of a brake system 1 according to the present embodiment as viewed from an angle. The brake system 1 includes a first unit 1A, a second unit 1B, and a third unit 1C. FIG. 2 illustrates a schematic configuration of the brake system 1 together with a hydraulic circuit. FIG. 2 illustrates a cross section passing through central axes of the first unit 1A and the third unit 1C. The brake system 1 is usable for a hybrid automobile including an electric motor (a generator) in addition to an internal combustion engine, an electric automobile including only the electric motor, and the like, besides a general vehicle including only the internal combustion engine (an engine) as a prime mover that drives wheels. The system 1 is a hydraulic braking apparatus that provides a frictional braking force with use of a hydraulic pressure to each of wheels W (a front left wheel FL, a front right wheel FR, a rear left wheel RL, and a rear right wheel RR) of the vehicle. A brake actuation unit is provided on each of the wheels W. The brake actuation unit is, for example, a disk-type brake, and includes a wheel cylinder W/C and a caliper. The caliper is actuated by the hydraulic pressure in the wheel cylinder W/C to generate the frictional braking force.

The brake system 1 includes brake pipes of two systems (a primary P system and a secondary S system). The brake system 1 supplies brake fluid as hydraulic fluid (hydraulic liquid) to each of the brake actuation units via pipes (brake pipes), and generates the hydraulic pressure (a brake hydraulic pressure) in the wheel cylinder W/C. By this frictional force, the brake system 1 applies a hydraulic braking force to each of the wheels W. A pipe configuration is, for example, an X-split pipe configuration. The brake system 1 may employ another pipe configuration, such as a front/rear split pipe configuration. Hereinafter, when a member provided in correspondence with the P system and a member provided in correspondence with the S system are distinguished from each other, indexes P and S will be added at the ends of the respective reference numerals. Each of the units 1A to 1C is set up in, for example, an engine room isolated from a driving compartment of the vehicle, and are connected to each other via master cylinder pipes 10M (a primary pipe 10MP and a secondary pipe 10MS) and an intake pipe 10R. The second unit 1B and the wheel cylinder W/C on each of the wheels W are connected to each other via a wheel cylinder pipe 10W. The pipes 10M and 10W are each a metallic brake pipe (a metallic pipe). The pipe 10R is a brake hose (a hose pipe) formed so as to become flexible from a material such as rubber. Hereinafter, a three-dimensional orthogonal coordinate system having an X axis, a Y axis, and a Z axis is set for convenience of the description. A Z-axis direction is defined to be a vertical direction and a Z-axis positive direction side is defined to be an upper side in the vertical direction with each of the units 1A to 1C mounted on the vehicle. An X-axis direction is defined to be a longitudinal direction of the vehicle and an X-axis positive direction side is defined to be a front side of the vehicle. A Y-axis direction is defined to be a lateral direction of the vehicle.

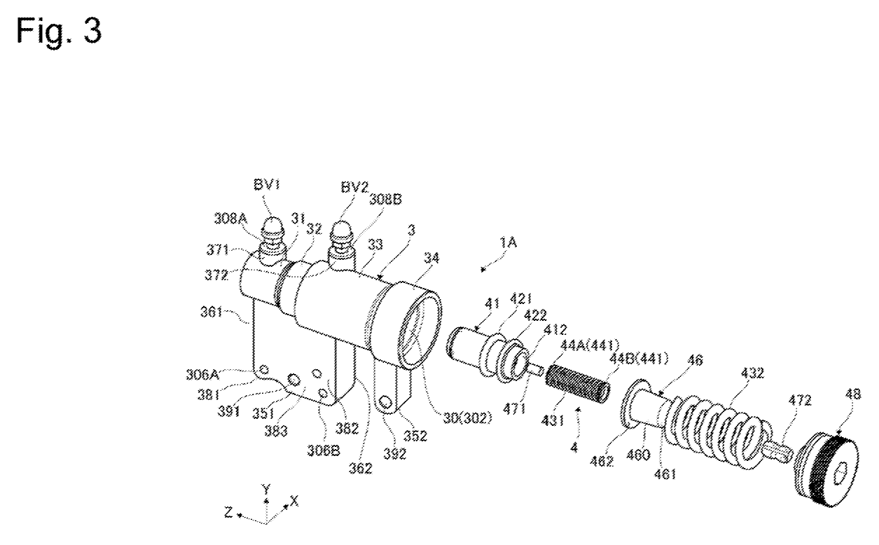

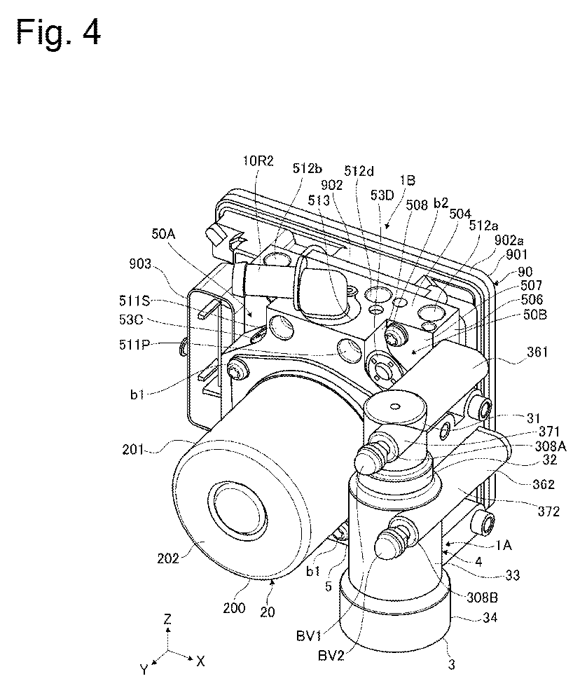

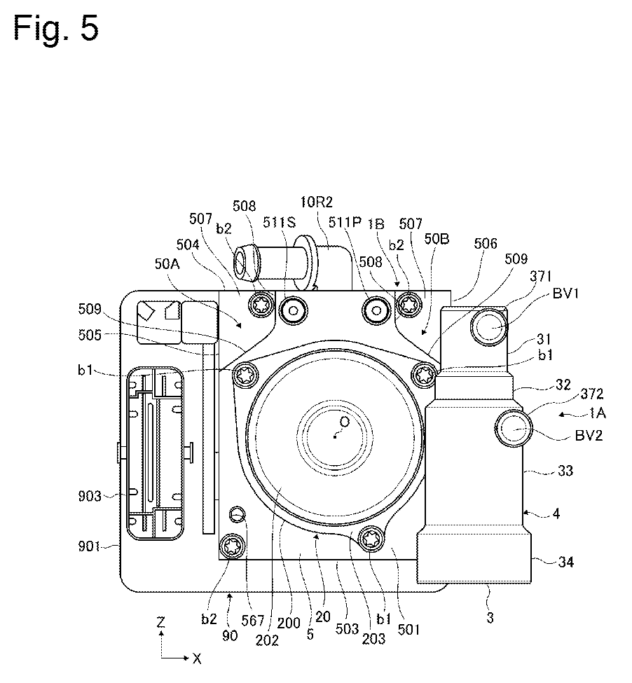

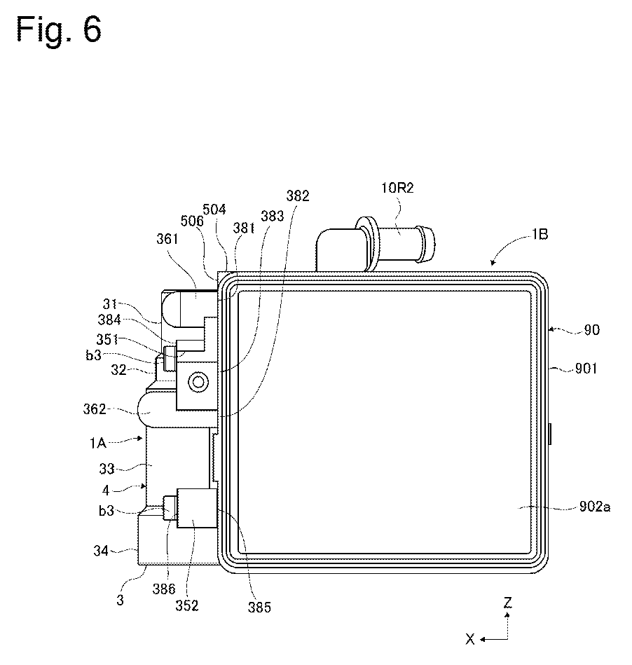

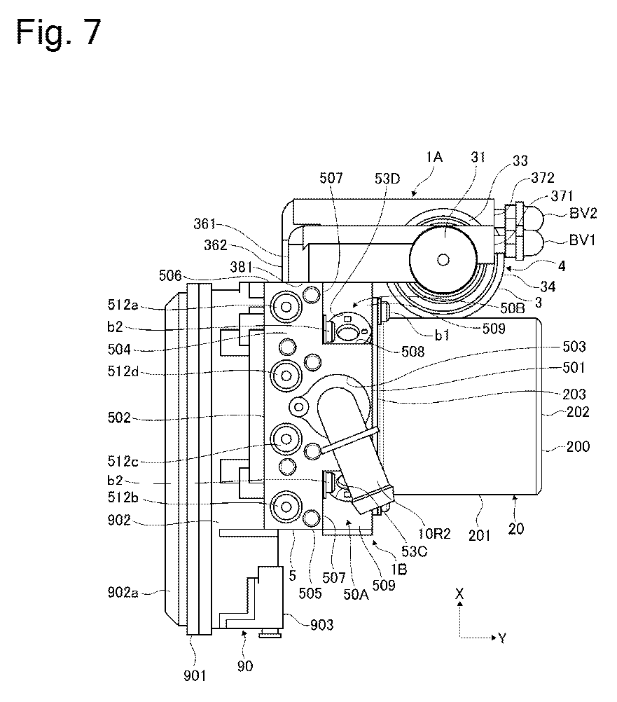

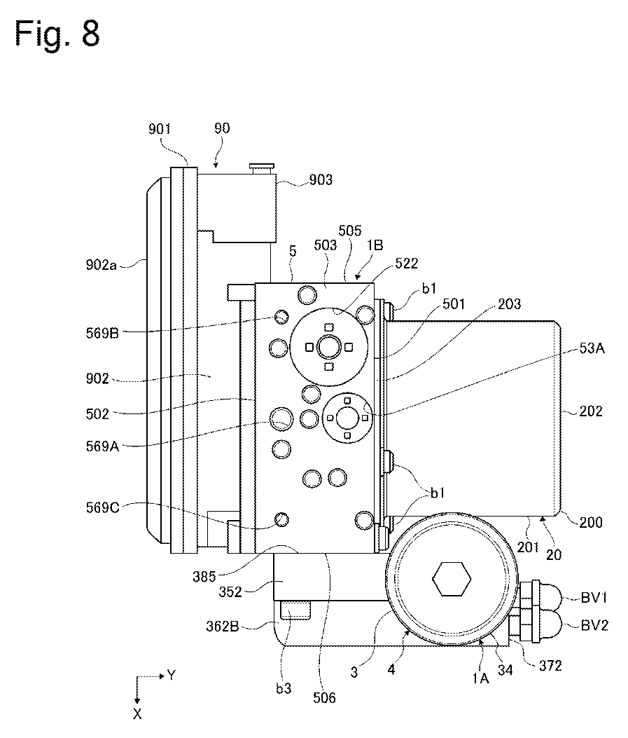

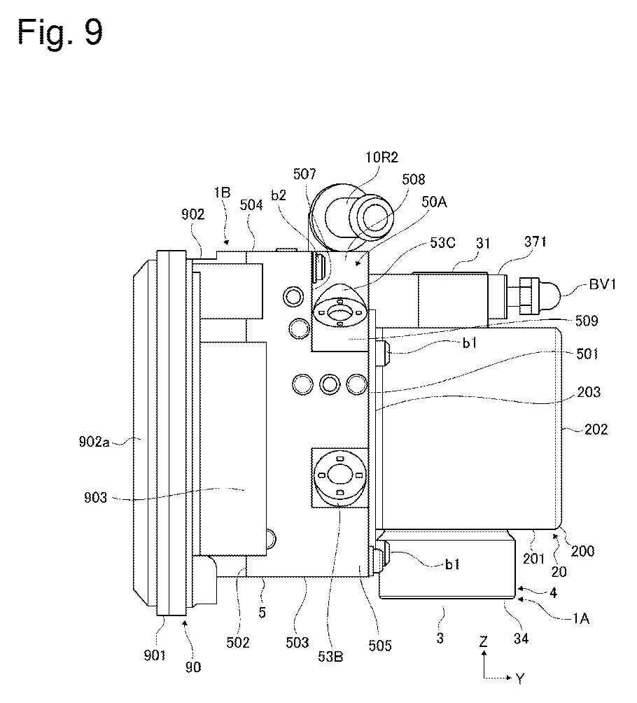

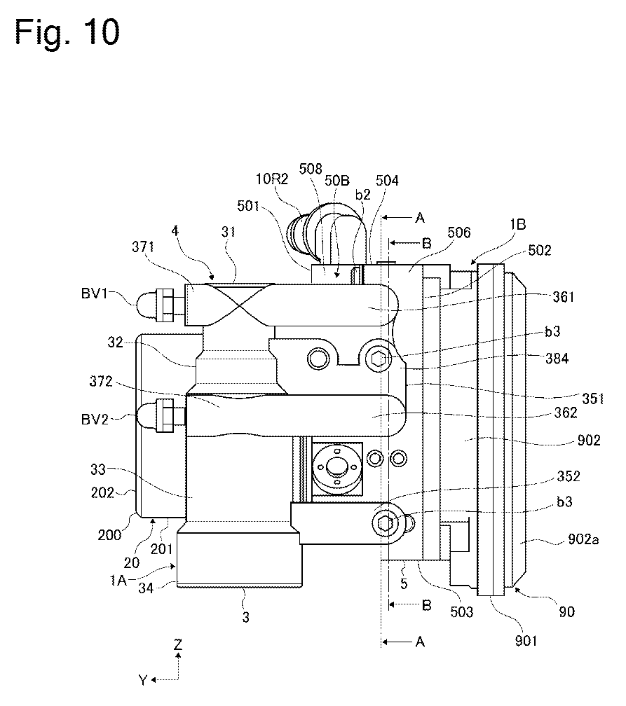

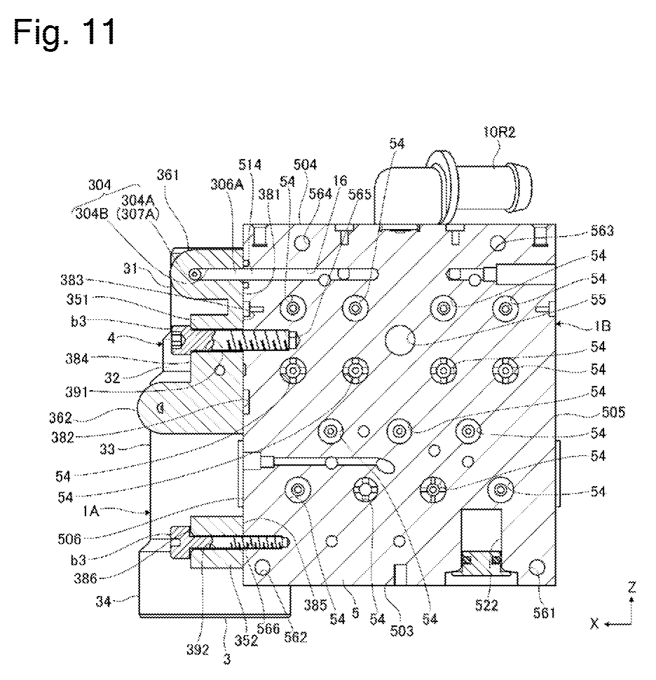

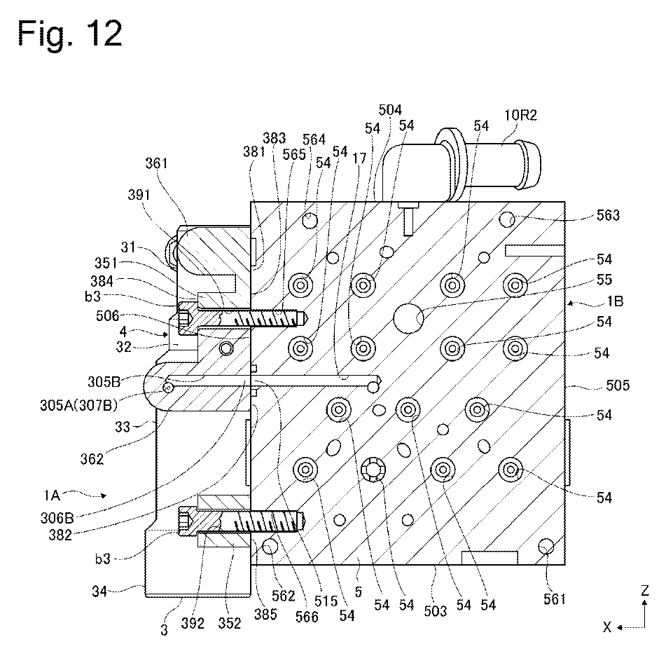

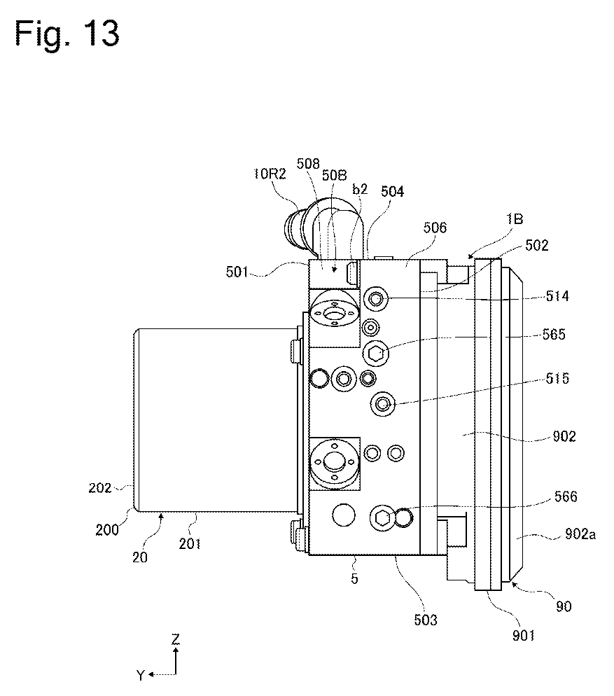

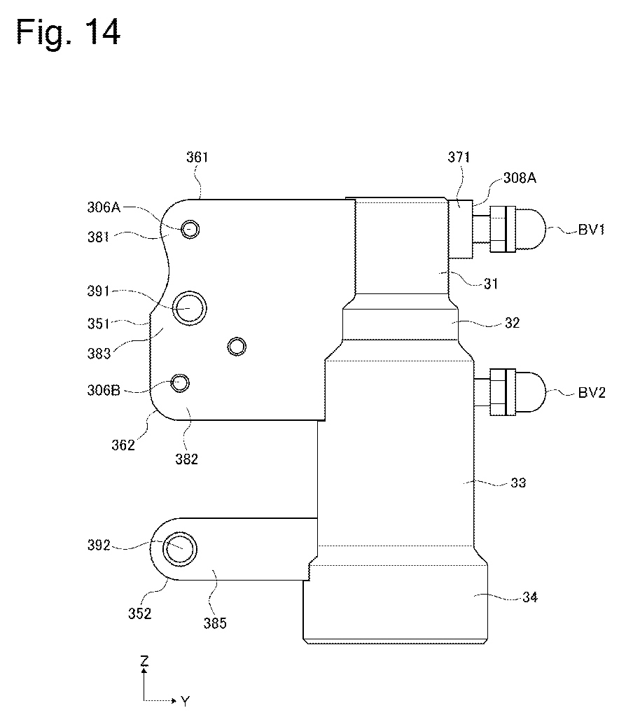

The first unit 1A is a stroke simulator unit including a stroke stimulator 4. The second unit 1B is a hydraulic control apparatus provided between a master cylinder 7 and the brake actuation unit of each of the wheels W. The first unit 1A and the second unit 1B are integrally provided, and are set on the vehicle as one unit. The third unit 1C is a brake operation unit mechanically connected to the brake pedal BP, and is a master cylinder unit including the master cylinder 7. A brake pedal BP is a brake operation member that receives an input of a brake operation performed by an operator (a driver). The third unit 1C is provided as a different unit from the first unit 1A and the second unit 1B, and is set on the vehicle spatially separately from the first unit 1A and the second unit 1B. FIG. 3 is a perspective view of the first unit 1A disassembled for each part and aligned concentrically. For convenience of the description, a coordinate system similar to FIG. 1 is set therein. FIGS. 4 to 10 illustrate an outer appearance of the second unit 1B with the first unit 1A attached thereto as viewed from each direction. FIG. 4 is a perspective view of the first unit 1A and the second unit 1B as viewed from an angle (the X-axis positive direction side, a Y-axis positive direction side, and the Z-axis positive direction side). FIG. 5 is a front view as viewed from the Y-axis positive direction side. FIG. 6 is a back view as viewed from a Y-axis negative direction side. FIG. 7 is a top view as viewed from the Z-axis positive direction side. FIG. 8 is a bottom view as viewed from a Z-axis negative direction side. FIG. 9 is a left side view as viewed from an X-axis negative direction side. FIG. 10 is a right side view as viewed from the X-axis positive direction side. FIG. 11 is a cross-sectional view taken along a line A-A illustrated in FIG. 10. FIG. 12 is a cross-sectional view taken along a line B-B illustrated in FIG. 10. FIG. 13 is a right side view of the outer appearance of the second unit 1B as viewed from the X-axis positive direction side. FIG. 14 is a left side view of an outer appearance of the first unit 1A as viewed from the X-axis negative direction side.

First, a configuration of the first unit 1A will be described. The first unit 1A includes a housing 3 and the stroke simulator 4. The housing 3 contains (houses) the stroke simulator 4 therein. The stroke simulator 4 is activated according to the brake operation performed by the driver, and provides a reaction force and a stroke to the brake pedal BP. The housing 3 is formed by, for example, preparing a parent material thereof by casting with use of an aluminum alloy as a material and making each portion by machining processing. The housing 3 has a stepped cylindrical shape, and includes a small-diameter portion 31, an intermediate portion 32, a large-diameter portion 33, and an end portion 34 in this order from the Z-axis positive direction side toward the Z-axis negative direction side. Outer diameters of them is increasing in order of the small-diameter portion 31, the intermediate portion 32, the large-diameter portion 33, and the end portion 34. The housing 3 includes a first flange portion 351, a second flange portion 352, a first fluid passage portion 361, a second fluid passage portion 362, a first bleeder portion 371, and a second bleeder portion 372. These first flange portion 351 and the like protrude outward from an outer surface of the housing 3. The first fluid passage portion 361 is disposed at an end of the small-diameter portion 31 in the Z-axis positive direction. The second fluid passage portion 362 is disposed at an end of the large-diameter portion 33 in the Z-axis positive direction. The first flange portion 351 is disposed so as to extend over a Z-axis negative direction side of the small-diameter portion 31 and the intermediate portion 32 (between the first fluid passage portion 361 and the second fluid passage portion 362 in the Z-axis direction). The second flange portion 352 is disposed so as to extend over the large-diameter portion 33 and the end portion 34 in the Z-axis direction. The first fluid passage portion 361 extends in the Y-axis negative direction from an end of the small-diameter portion 31 in the X-axis positive direction. As viewed from the X-axis positive direction side, the first fluid passage portion 361 has linear ends as both ends in the Z-axis direction, and a semi-circular end in the Y-axis negative direction. As viewed from the Y-axis direction, the first fluid passage portion 361 has linear ends as both ends in the Z-axis direction, and a semi-circular end in the X-axis positive direction. The first fluid passage portion 361 has a surface 381 generally in parallel with a YZ plane on an end thereof in the X-axis negative direction. As viewed from the Z-axis direction, the surface 381 is located on the X-axis positive direction side with respect to an end surface of the small-diameter portion 31 on the X-axis negative direction side. The second fluid passage portion 362 extends in the Y-axis negative direction from an end of the large-diameter portion 33 in the X-axis positive direction. As viewed from the X-axis direction, the second fluid passage portion 362 has linear ends as both ends in the Z-axis direction, and a semi-circular end in the Y-axis negative direction. As viewed from the Y-axis direction, the second fluid passage portion 362 has linear ends as both ends in the Z-axis direction, and a semi-circular end in the X-axis positive direction. The second fluid passage portion 362 has a surface 382 generally in parallel with the YZ plane on an end thereof in the X-axis negative direction. As viewed from the Z-axis direction, the surface 382 is located on the X-axis positive direction side with respect to the end surface of the small-diameter portion 31 on the X-axis negative direction side. The first flange portion 351 extends in the Y-axis negative direction from an intermediate portion between the small-diameter portion 31 and the intermediate portion 32 in the X-axis direction. As viewed from the X-axis direction, an end of the first flange portion 351 in the Y-axis negative direction has a shape curved convexly toward the Y-axis positive direction in an approximately half region on the Z-axis positive direction side, and a linear shape in an approximately half region on the Z-axis negative direction side. As viewed from the Y-axis direction, the first flange portion 351 has linear ends as both ends in the X-axis direction. The first flange portion 351 has a plane 383 generally in parallel with the YZ plane on the end thereof in the X-axis negative direction, and a plane 384 generally in parallel with the YZ plane on the end thereof in the X-axis positive direction. A bolt hole 391 extending in the X-axis direction penetrates through an approximately central position of the first flange portion 351 in the Z-axis direction. The bolt hole 391 is opened on the surfaces 383 and 384. The second flange portion 352 extends in the Y-axis negative direction from an intermediate portion between the large-diameter portion 33 and the end portion 34 in the X-axis direction. As viewed from the X-axis direction, the second flange portion 352 has linear ends as both ends in the Z-axis direction, and a semi-circular end in the Y-axis negative direction. As viewed from the Y-axis direction, the second flange portion 352 has linear ends as both ends in the X-axis direction. The second flange portion 352 has a plane 385 generally in parallel with the YZ plane on the end thereof in the X-axis negative direction, and a plane 386 generally in parallel with the YZ plane on the end thereof in the X-axis positive direction. As viewed from the Z-axis direction, the surface 385 is located on the X-axis positive direction side with respect to the end surface of the small-diameter portion 31 on the X-axis negative direction side. When being viewed from the X-axis positive direction, the second flange portion 352 includes a bolt hole 392 penetrating therethrough, which extends in the X-axis direction with a central axis thereof set on a center of the semi-circle on the Y-axis negative direction side. The bolt hole 392 is opened on the surfaces 385 and 386. Each of the bleeder portions 371 and 372 is cylindrical. The first bleeder portion 371 extends toward the Y-axis positive direction side from a position that is the end of the small-diameter portion 31 in the X-axis positive direction and approximately the same position as the first fluid passage portion 361 in the Z-axis direction (the end of the small-diameter portion 31 in the Z-axis positive direction). The second bleeder portion 372 extends toward the Y-axis positive direction side from a position that is the end of the small-diameter portion 33 in the X-axis positive direction and approximately the same position as the second fluid passage portion 362 in the Z-axis direction (the end of the large-diameter portion 33 in the Z-axis positive direction). An end of each of the bleeder portions 371 and 372 in the Y-axis positive direction extends generally in parallel with the XZ plane, and is located between the end of the large-diameter portion 33 in the Y-axis positive direction and the end of the end portion 34 in the Y-axis positive direction.

The first flange portion 351, the first fluid passage portion 361, and the second fluid passage portion 362 are integrally continuously provided. The end of the first flange portion 351 in the Z-axis positive direction is continuous to the first fluid passage portion 361, and the end of the first flange portion 351 in the Z-axis negative direction is continuous to the second fluid passage portion 362. The end of the first fluid passage portion 361 in the Y-axis negative direction is located slightly on the Y-axis positive direction side with respect to the end of the first flange portion 351 in the Y-axis negative direction. The end of the second fluid passage portion 362 in the Y-axis negative direction approximately coincides with the end of the first flange portion 351 in the Y-axis negative direction, and approximately coincides with the end of the second flange portion 352 in the Y-axis negative direction. The ends of the first flange portion 351, the second flange portion 352, the first fluid passage portion 361, and the second fluid passage portion 362 in the X-axis negative direction approximately coincide with one another. In other words, the surfaces 381, 382, 383, and 385 are located on approximately the same plane. The surfaces 381, 382, 383, and 385 are located slightly on the X-axis positive direction side with respect to the end of the small-diameter portion 31 in the X-axis negative direction. The ends of the first flange portion 351 and the second flange portion 352 in the X-axis positive direction approximately coincide with each other. In other words, the surfaces 384 and 386 are located on approximately the same plane. The end of the first fluid passage portion 361 in the X-axis positive direction is located slightly on the X-axis positive direction side with respect to the end of the first flange portion 351 in the X-axis positive direction, and approximately coincides with the end of the small-diameter portion 31 in the X-axis positive direction. The end of the second fluid passage portion 362 in the X-axis positive direction is located on the X-axis positive direction side with respect to the end of the first fluid passage portion 361 in the X-axis positive direction, and is located slightly on the X-axis positive direction side with respect to the end of the large-diameter portion 33 in the X-axis positive direction.

A cylinder 30, a plurality of fluid passages, and a plurality of ports are formed inside the housing 3. The cylinder 30 has a bottomed cylindrical shape extending in the Z-axis direction, and is closed and opened on the Z-axis positive direction side (the small-diameter portion 31 side) and the Z-axis negative direction side (the end portion 34 side) thereof, respectively. The cylinder 30 includes a small-diameter portion 301 and a large-diameter portion 302 on the Z-axis positive direction side (an inner peripheral side of the small-diameter portion 31) and the Z-axis negative direction side (an inner peripheral side of the large-diameter portion 33) thereof, respectively. A first seal groove 303A and a second seal groove 303B are provided on the small-diameter portion 301 at an approximately central position in the Z-axis direction and on the Z-axis negative direction side, respectively. The seal grooves 303 each have an annular shape extending in a direction around a central axis of the cylinder 30. The plurality of fluid passages includes a first connection fluid passage 304 and a second connection fluid passage 305 as a simulator connection fluid passage, and a first bleeder fluid passage 307A and a second bleeder fluid passage 307B. The plurality of ports includes a simulator first connection port 306A and a simulator second connection port 306B as a simulator connection port, and a first bleeder port 308A and a second bleeder port 308B.

The simulator first connection port 306A has a cylindrical shape extending in the X-axis direction inside the first fluid passage portion 361, and is opened on the surface 381. The first connection fluid passage 304 includes a first portion 304A and a second portion 304B. The first portion 304A has one end connected (opened) to the Z-axis positive direction side, the X-axis positive direction side, and the Y-axis negative direction side of the small-diameter portion 301, and extends from this one end in the Y-axis negative direction inside the first fluid passage portion 361. The first portion 304A extends on a center of the above-described semi-circle of the first fluid passage portion 361, which is semi-circular as viewed from the Y-axis direction. The second portion 304B has one end connected to an end of the first portion 304A in the Y-axis negative direction, and also extends from this one end toward the X-axis negative direction side (by being bent approximately perpendicularly to the first portion 304A) inside the first fluid passage portion 361 to be connected (opened) to the port 306A on an X-axis negative direction side thereof. The second portion 304B and the port 306A extends on a center of the above-described semi-circle of the first fluid passage portion 361, which is semi-circular as viewed from the X-axis direction. The simulator second connection port 306B has a cylindrical shape extending in the X-axis direction inside the second fluid passage portion 362, and is opened on the surface 382. The second connection fluid passage 305 includes a first portion 305A and a second portion 305B. The first portion 305A has one end connected (opened) to the Z-axis positive direction side, the X-axis negative direction side, and the Y-axis negative direction side of the large-diameter portion 302, and extends from this one end in the Y-axis negative direction inside the second fluid passage portion 362. The second portion 305B has one end connected to an end of the first portion 305A in the Y-axis negative direction, and also extends from this one end toward the X-axis negative direction side (by being bent approximately perpendicularly to the first portion 305A) inside the second fluid passage portion 362 to be connected (opened) to the port 306B on an X-axis negative direction side thereof. The second portion 305B and the port 306B extend on a center of the above-described semi-circle of the second fluid passage portion 362, which is semi-circular as viewed from the X-axis direction.

The first bleeder port 308A has a cylindrical shape extending in the Y-axis direction on a central axis of the first bleeder portion 371, and is opened on an end surface of the first bleeder portion 371 in the Y-axis positive direction. The second bleeder port 308B has a cylindrical shape extending in the Y-axis direction on a central axis of the second bleeder portion 372, and is opened on an end surface of the second bleeder portion 372 in the Y-axis positive direction. A first bleeder valve BV1 and a second bleeder valve BV2 are attached to the first bleeder port 308A and the second bleeder port 308B, respectively. The first bleeder fluid passage 307A extends in the Y-axis direction on the central axis of the first bleeder portion 371. One end and the other end of the first bleeder fluid passage 307A are connected (opened) to a positive pressure chamber 401 and the first bleeder port 308A, respectively. The first bleeder fluid passage 307A extends on approximately the same straight line as the first portion 304A of the first connection fluid passage 304. The second bleeder fluid passage 307B extends in the Y-axis direction on the central axis of the second bleeder portion 372. One end and the other end of the second bleeder fluid passage 307B are connected (opened) to a back-pressure chamber 402 and the second bleeder port 308B, respectively. The second bleeder fluid passage 307B extends on approximately the same straight line as the first portion 305A of the second connection fluid passage 305.

The stroke simulator 4 includes a piston 41, a first seal member 421, a second seal member 422, a first spring 431, a second spring 432, a first retainer member 44A, a second retainer member 44B, a stopper member 45, a seat member 46, a first damper 471, a second damper 472, and a plug member 48. The piston 41 has a bottomed cylindrical shape, and is contained in the cylinder 30. The piston 41 includes a first recessed portion 411 opened to the Z-axis positive direction side and a second recessed portion 412 opened to the Z-axis negative direction side. The recessed portions 411 and 412 are separated by a wall portion 410. A cylindrical protrusion portion 413 protrudes from the wall portion 41 inside the second recessed portion 412. The piston 41 is movable in the Z-axis direction along the inner peripheral surface of the small-diameter portion 301. An inside of the cylinder 30 is partitioned and divided into two chambers by the piston 41. The positive pressure chamber (a main chamber) 401 as a first chamber is defined between a Z-axis positive direction side (including an inner peripheral side of the first recessed portion 411) of the piston 41 and the small-diameter portion 301. The back-pressure chamber (a sub chamber) 402 as a second chamber is defined between a Z-axis negative direction side of the piston 41 and the large-diameter portion 302. The first connection fluid passage 304 is constantly opened to the positive pressure chamber 401, and the second connection fluid passage 305 is constantly opened to the back-pressure chamber 402. The first and second seal members 421 and 422 are set in the first and second seal grooves 303A and 303B, respectively. The seal members 421 and 422 are cup-shaped, and lip portions therefore are in sliding contact with an outer peripheral surface of the piston 41. The first seal member 421 prohibits a flow of the brake fluid directed from the Z-axis positive direction side (the positive pressure chamber 401) toward the Z-axis negative direction side (the back-pressure chamber 402). The second seal member 422 prohibits a flow of the brake fluid directed from the Z-axis negative direction side (the back-pressure chamber 402) toward the Z-axis positive direction side (the positive pressure chamber 401). The positive pressure chamber 401 and the back-pressure chamber 402 are liquid-tightly separated from each other by the seal members 421 and 422. Each of the seal members 421 and 422 may be an X-ring, or may be configured in such a manner that two cup-like seal members are arranged and disposed so as to be able to prohibit the flows of the brake fluid to both the positive pressure chamber 401 and the back-pressure chamber 402. Further, in the present embodiment, the seal grooves 303A and 303B are provided to the cylinder 30 as a structure for setting the seal members 421 and 422 (the seal members 421 and 422 are configured as so-called rod seals), but the seal grooves may be instead provided to the piston 41 (the seal members 421 and 422 may be configured so-called piston seals).

The springs 431 and 432, the retainer member 44, the stopper member 45, the seat member 46, the dampers 471 and 472 are contained in the back-pressure chamber 402. The first spring 431, the retainer member 44, and the stopper member 45 form one spring unit. The springs 431 and 432 are coil springs as elastic members. The first spring 431 is small in diameter, and the second spring 432 is large in diameter and has a greater spring coefficient than the first spring 431. The retainer member 44 includes a cylindrical portion 440. A first flange portion 441 flares radially outwardly on one axial end side of the cylindrical portion 440, and a second flange portion 442 flares radially inwardly on the other axial end side of the cylindrical portion 440. The first spring 431 is set in a pressed and compressed state between the first retainer member 44A (the first flange portion 441 thereof) and the second retainer member 44B (the first flange portion 441 thereof). The stopper member 45 has a bolt-like shape including a shaft portion 450, and a head portion 451 thereof flares radially outwardly at one end of the shaft portion 450. The other end of the shaft portion 450 is fixed to the second flange portion 442 of the second retainer member 44B. The head portion 451 is contained on an inner peripheral side of the cylindrical portion 440 of the first retainer member 44A movably along an inner peripheral surface of the cylindrical portion 440. A length of the first spring 431 is maximized with the head portion 451 in abutment with the second flange portion 442.

The seat member 46 has a bottomed cylindrical shape including a cylindrical portion 460 and a bottom portion 461, and a flange portion 462 flares radially outwardly on an opening side of the cylindrical portion 460. The first damper 471 is an elastic member such as rubber, and has a columnar shape. The second damper 472 is an elastic member such as rubber, and has a columnar shape narrowed at an axially central portion thereof. A plug member 48 is fixed to the end portion 34, and liquid-tightly closes the opening of the cylinder 30 (the large-diameter portion 302). On a Z-axis positive direction side of the plug member 48, a bottomed cylindrical first recessed portion 481 is provided, and a bottomed annular second recessed portion 482 is also provided so as to surround the first recessed portion 481. The second damper 472 is set in the first recessed portion 481. The unit of the first spring 431 is set between the piston 41 and the seat member 46. The first flange portion 441 of the first retainer member 44A is set on the partition wall 410 of the piston 41. A Z-axis positive direction side of the cylindrical portion 440 of the first retainer member 44A is fitted to the protrusion portion 413. The first damper 471 is set in abutment with the protrusion portion 413 on an inner peripheral side of the cylindrical portion 440. The second retainer member 44B is set on an inner peripheral side of the seat member 46 (the cylindrical portion 460), and the flange portion 441 is in abutment with the bottom portion 461. The second spring 432 is set between the seat member 46 and the plug member 48. A Z-axis positive direction side of the second spring 432 is fitted to the cylindrical portion 460 of the seat member 46 and held by the seat member 46. A Z-axis negative direction side of the second spring 432 is contained in the second recessed portion 482 of the plug member 48 and held by the plug member 48. The second spring 432 is set in a pressed and compressed state between the flange portion 462 of the seat member 46 and the plug member 48 (a bottom portion of the second recessed portion 482). The first and second springs 431 and 432 each function as a return spring constantly biasing the piston 41 toward the positive pressure chamber 401 side (a direction for reducing a volume of the positive pressure chamber 401 and increasing a volume of the back-pressure chamber 402).

Next, a configuration of the second unit 1B will be described. The second unit 1B is a hydraulic unit that generates the hydraulic pressures in the wheel cylinders W/C via the fluid passages. The second unit 1B includes a housing 5, a motor 20, a pump 2, a plurality of electromagnetic valves 21 and the like, a plurality of hydraulic sensors 91 and the like, and an electronic control unit (a control unit, hereinafter referred to as an ECU) 90. The housing 5 contains (houses) the pump 2 and valve bodies of the electromagnetic valves 21 and the like therein. Circuits (brake hydraulic circuits) of the P system and the S system, through which the brake fluid flows, are formed by a plurality of fluid passages 11 and the like inside the housing 5. Further, a plurality of ports 51 is formed inside the housing 5, and these ports 51 are opened on an outer surface of the housing 5. These fluid passages 11 and the like and ports 51 are formed by machining processing using a drill or the like. The plurality of ports 51 is continuous to the fluid passages 11 and the like inside the housing 5, and connects the fluid passages 11 and the like and the fluid passages (the pipe 10M and the like) outside the housing 5 to each other. The fluid passages 11 and the like include supply fluid passages 11, an intake fluid passage 12, a discharge fluid passage 13, a pressure adjustment fluid passage 14, pressure reduction fluid passages 15, a positive pressure fluid passage 16, a back-pressure fluid passage 17, a first simulator fluid passage 18, and a second simulator fluid passage 19.

The plurality of ports 51 includes master cylinder ports 511 (a primary port 511P and a secondary port 511S), wheel cylinder ports 512, an intake port 513, a unit first connection port (a positive pressure port) 514, and a unit second connection port (a back-pressure port) 515. The master cylinder ports 511 are connected to the supply fluid passages 11, and also connect the housing 5 (the second unit 1B) to the master cylinder 7 (the hydraulic chambers 70) via the master cylinder pipes 10M. The ports 511 are master cylinder connection ports, and one end of the primary pipe 10MP and one end of the secondary pipe 10MS are connected to the primary port 511P and the secondary port 511S, respectively. The wheel cylinder ports 512 are connected to the supply fluid passages 11, and also connect the housing 5 (the second unit 1B) to the wheel cylinders W/C via the wheel cylinder pipes 10W. The ports 512 are wheel cylinder connection ports, and one ends of the wheel cylinder pipes 10W are connected to the ports 512. The intake port 513 is connected to a first fluid pool chamber 521 inside the housing 5, and also connects the housing 5 to a reservoir tank 8 (a second chamber 83R) via the intake pipe 10R. A nipple 10R2 is fixedly set in the intake port 513, and one end of the intake pipe 10R is connected to the nipple 10R2. The unit first connection port 514 is connected to the positive pressure fluid passage 16, and also connects the housing 5 to the stroke simulator 4 (the positive pressure chamber 401). The simulator first connection port 306A of the first unit 1A is connected to the port 514. The unit second connection port 515 is connected to the back-pressure fluid passage 17, and also connects the housing 5 to the stroke simulator 4 (the back-pressure chamber 402). The simulator second connection port 306B of the first unit 1A is connected to the port 515.

The motor 20 is a rotary electric motor, and includes a rotational shaft for driving the pump 2. The motor 20 may be a brushed motor, or may be a brushless motor including a resolver that detects a rotational angle or the number of rotations of the above-described rotational shaft. The pump 2 is a first hydraulic source capable of supplying the hydraulic pressures to the wheel cylinders W/C, and includes a plurality of (five) pump portions 2A to 2E configured to be driven by one motor 20. The pump 2 is a radial plunger pump in the form of a fixed cylinder, and is used by the S system and the P system in common. The electromagnetic valves 21 and the like are each an actuator that operates according to a control signal, and each include a solenoid and a valve body. The valve body performs a stroke according to power supply to the solenoid to switch opening/closing of the fluid passage 11 or the like (establishes or blocks communication through the fluid passage 11 or the like). The electromagnetic valves 21 and the like each generate a control hydraulic pressure by controlling a communication state of the above-described circuit to adjust a flow state of the brake fluid. The electromagnetic valves 21 and the like include shut-off valves 21, pressure increase valves (hereinafter referred to as SOL/INs) 22, communication valves 23, a pressure adjustment valve 24, pressure reduction valves (hereinafter referred to as SOL/V OUTs) 25, a stroke simulator IN valve (hereinafter referred to as an SS/V IN) 28, and a stroke simulator out valve (hereinafter referred to as an SS/V OUT) 29. The valves 21, 22, and 24 are normally opened valves opened with no power supplied thereto, and the valves 23, 25, 28, and 29 are normally closed valves closed with no power supplied thereto. The valves 21, 22, and 24 are each a proportional control valve, an opening degree of which is adjusted according to a current supplied to the solenoid. The valves 23, 25, 28, and 29 are each an ON/OFF valve, opening/closing of which is controlled to be switched between two values, i.e., switched to be either opened or closed. The proportional control valve can also be used as these valves 23, 25, 28, and 29. The hydraulic sensors 91 and the like detect a discharge pressure of the pump 2 and a master cylinder pressure. The plurality of hydraulic sensors 91 and the like include a master cylinder pressure sensor 91, wheel cylinder pressure sensors 92 (a primary pressure sensor 92P and a secondary pressure sensor 92S), and a discharge pressure sensor 93.

In the following description, the brake hydraulic circuit of the second unit 1B will be described with reference to FIG. 2. Members corresponding to the individual wheels W (FL), W (FR), W (RL), and W (RR) will be distinguished from one another if necessary, by indexes a to d added at the ends of reference numerals thereof, respectively. One end side of the supply fluid passage 11P is connected to the primary port 511P. The other end side of the fluid passage 11P branches off into a fluid passage 11a for the front left wheel and a fluid passage 11d for a rear right wheel 11d. One end side of the fluid passage 11S is connected to the secondary port 511S. The other end side of the fluid passage 11S branches off into a fluid passage 11b for the front right wheel and a fluid passage 11c for the rear left wheel. The fluid passages 11a to 11d are connected to the wheel cylinder ports 512a to 512d corresponding thereto, respectively. The shut-off valves 21 are provided on the above-described one end sides of the fluid passages 11. The SOL/V IN 22 is provided in each of the fluid passages 11a to 11d. A bypass fluid passage 110 is provided in parallel with each of the fluid passages 11 while bypassing the SOL/V IN 22, and a check valve 220 is provided in the fluid passage 110. The valve 220 permits only a flow of the brake fluid directed from the wheel cylinder port 512 side toward the master cylinder port 511 side. The positive pressure fluid passage 16 branches off from a portion in the fluid passage 11S between the secondary port 511S and the shut-off valve 21S. One end side and the other end side of the positive pressure fluid passage 16 are connected to the fluid passage 11S and the positive pressure port 514, respectively.

The intake fluid passage 12 connects the first fluid pool chamber 521 and an intake portion of the pump 2 to each other. One end side of the discharge fluid passage 13 is connected to a discharge portion of the pump 2. The other end side of the discharge fluid passage 13 branches off into a fluid passage 13P for the P system and a fluid passage 13S for the S system. Each of the fluid passages 13P and 13S is connected to a portion in the supply fluid passage 11 between the shut-off valve 21 and the SOL/V IN 22. The communication valve 23 is provided in each of the fluid passages 13P and 13S. Each of the fluid passages 13P and 13S functions as a communication passage connecting the supply fluid passage 11P of the P system and the supply fluid passage 11S of the S system to each other. The pump 2 is connected to each of the wheel cylinder ports 512 via the above-described communication passages (the discharge fluid passages 13P and 13S) and the supply fluid passages 11P and 11S. The pressure adjustment fluid passage 14 connects a portion in the discharge fluid passage 13 between the pump 2 and the communication valves 23, and the first fluid pool chamber 521 to each other. The pressure adjustment valve 24 as a first pressure reduction valve is provided in the fluid passage 14. The pressure reduction fluid passage 15 connects a portion in each of the fluid passages 11a to 11d between the SOL/V IN 22 and the wheel cylinder port 512, and the first fluid pool chamber 521 to each other. The SOL/V OUTs 25 as second pressure reduction valves are provided in the fluid passages 15.

One end side of the back-pressure fluid passage 17 is connected to the back-pressure port 515. The other end side of the fluid passage 17 branches off into the first simulator fluid passage 18 and the second simulator fluid passage 19. The first simulator fluid passage 18 is connected to a portion in the supply fluid passage 11S between the shut-off valve 21S and the SOL/V INs 22b and 22c. The SS/V IN 28 is provided in the fluid passage 18. A bypass fluid passage 180 is provided in parallel with the fluid passage 18 while bypassing the SS/V IN 28, and a check valve 280 is provided in the fluid passage 180. The valve 280 permits only a flow of the brake fluid directed from the back-pressure fluid passage 17 side toward the supply fluid passage 11S side. The second simulator fluid passage 19 is connected to the first fluid pool chamber 521. The SS/V OUT 29 is provided in the fluid passage 19. A bypass fluid passage 190 is provided in parallel with the fluid passage 19 while bypassing the SS/V OUT 29, and a check valve 290 is provided in the fluid passage 190. The valve 290 permits only a flow of the brake fluid directed from the first fluid pool chamber 521 side toward the back-pressure fluid passage 17 side. The hydraulic sensor 91 is provided between the shut-off valve 21S and the secondary port 511S in the supply fluid passage 11S. The hydraulic sensor 91 detects a hydraulic pressure at this portion (a hydraulic pressure in the positive pressure chamber 401 of the stroke simulator 4, and the master cylinder pressure). The hydraulic sensors 92 are provided between the shut-off valves 21 and the SOL/V INs 22 in the supply fluid passages 11. The hydraulic sensors 92 detect hydraulic pressures at these portions (corresponding to the wheel cylinder hydraulic pressures). The hydraulic sensor 93 is provided between the pump 2 and the communication valves 23 in the discharge fluid passage 13. The hydraulic sensor 93 detects a hydraulic pressure at this portion (a pump discharge pressure).

The housing 5 of the second unit 1B is a generally cuboidal block formed with use of aluminum alloy as a material thereof. The outer surface of the housing 5 includes a front surface 501, a back surface 502, a bottom surface 503, a top surface 504, a left side surface 505, and a right side surface 506. The front surface 501 is a flat surface relatively large in area. The back surface 502 is a flat surface generally in parallel with the front surface 501, and is located opposite (of the housing 5) from the front surface 501. The bottom surface 503 is a flat surface continuous to the front surface 501 and the back surface 502. The top surface 504 is a flat surface generally in parallel with the bottom surface 503, and is located opposite (of the housing 5) from the bottom surface 503. The left side surface 505 is a flat surface continuous to the front surface 501, the back surface 502, the bottom surface 503, and the top surface 504. The right side surface 506 is a flat surface generally in parallel with the left side surface 505, and is located opposite (of the housing 5) from the left side surface 505. The right side surface 506 is continuous to the front surface 501, the back surface 502, the bottom surface 503, and the top surface 504. The front surface 501 is disposed on the Y-axis positive direction side, and extends generally in parallel with the XZ plane with the housing 5 mounted on the vehicle. The back surface 502 is disposed on the Y-axis negative direction side, and extends generally in parallel with the XZ plane. The top surface 504 is disposed on the Z-axis positive direction side, and extends generally in parallel with the XY plane. The bottom surface 503 is disposed on the Z-axis negative direction side, and extends generally in parallel with the XY plane. The right side surface 506 is disposed on the X-axis positive direction side, and extends generally in parallel with the YZ plane. The left side surface 505 is disposed on the X-axis negative direction side, and extends generally in parallel with the YZ plane. In actual use, the layout of the housing 5 in the XY plane is not limited in any manner, and the housing 5 can be arranged in the XY plane at any position and in any orientation according to the vehicle layout and/or the like.

A recessed portion 50 is formed at each of corner portions of the housing 5 between the front surface 501 and the top surface 504. In other words, a vertex formed by the front surface 501, the top surface 504, and the right side surface 506, and a vertex formed by the front surface 501, the top surface 504, and the left side surface 505 have truncated shapes, and include second and first recessed portions 50B and 50A, respectively. The first recessed portion 50A is exposed (opened) on the front surface 501, the top surface 504, and the left side surface 505. The second recessed portion 50B is exposed (opened) on the front surface 501, the top surface 504, and the right side surface 506. The first recessed portion 50A includes a first flat surface portion 507, a second flat surface portion 508, and a third flat surface portion 509. The first flat surface portion 507 extends approximately perpendicularly to the Y axis and generally in parallel with the XZ plane. The second flat surface portion 508 extends approximately perpendicularly to the X axis and generally in parallel with the YZ plane. The third flat surface 509 extends in the Y-axis direction, and forms an angle of approximately 50 degrees with respect to the right side surface 506 in a counterclockwise direction as viewed from the Y-axis positive direction side. The second flat surface portion 508 and the third flat surface portion 509 are continuous to each other smoothly via a concaved curved surface extending in the Y-axis direction. A configuration of the second recessed portion 50B is similar to the first recessed portion 50A. The first and second recessed portions 50A and 50B are generally symmetric with respect to the YZ plane at a center of the housing 5 in the X-axis direction. The housing 5 includes the first fluid pool chamber 521, a second fluid pool chamber 522, a cam containing hole, a plurality of (five) cylinder containing holes 53A to 53E, a plurality of valve containing holes 54, a plurality of sensor containing holes, a power source hole 55, and a plurality of fixation holes 56 therein. These holes and chambers are also formed with use of a drill or the like.

The first fluid pool chamber 521 has a bottomed cylindrical shape extending in the Z-axis direction. The first fluid pool chamber 521 is opened on a portion of the top surface 504 that is approximately central in the X-axis direction and offset toward the Y-axis positive direction, and is disposed from the top surface 504 into the housing 5. The second fluid pool chamber 522 has a bottomed cylindrical shape having a central axis extending in the Z-axis direction. The second fluid pool chamber 522 is opened on a portion of the bottom surface 503 that is located on the X-axis negative direction side and offset toward the Y-axis positive direction, and is disposed from the bottom surface 503 into the housing 5. The cam containing hole has a bottomed cylindrical shape extending in the Y-axis direction, and is opened on the front surface 501. A central axis O of the cam containing hole is disposed at a position of the front surface 501 that is approximately central in the X-axis direction and slightly on the Z-axis negative direction side with respect to a center in the Z-axis direction. Each of the cylinder containing holes 53 has a stepped cylindrical shape, and has a central axis extending in a radial direction of the cam containing hole (a radial direction around the central axis O). Parts of the holes 53A to 53E on one side closer to the cam containing hole (the central axis O) function as intake portions of the pump portions 2A to 2E, respectively, and are connected to one another via a first communication fluid passage. Parts of the holes 53A to 53E on the other side farther from the cam containing hole (the central axis O) function as discharge portions of the pump portions 2A to 2E, respectively, and are connected to one another via a second communication fluid passage. The plurality of holes 53A to 53E is disposed generally evenly (at generally even intervals) in a direction around the central axis O. The holes 53A to 53E are arrayed in one row along the Y-axis direction, and are disposed on a Y-axis positive direction side of the housing 5. In other words, central axes of the holes 53A to 53E are located in generally the same plane approximately perpendicular to the central axis O. This plane extends approximately in parallel with the front surface 501 and the back surface 502, and is located closer to the front surface 501 side than to the back surface 502.

Each of the holes 53A to 53E is disposed inside the housing 5 in the following manner. The hole 53A extends from the bottom surface 503 toward the Z-axis positive direction side. The hole 53B extends from a portion of the left side surface 505 that is positioned on the Z-axis negative direction side with respect to the central axis O to the X-axis positive direction side and the Z-axis positive direction side. The hole 53C extends from the first recessed portion 50A to the X-axis positive direction side and the Z-axis negative direction side. The hole 53D extends from the second recessed portion 50B to the X-axis negative direction side and the Z-axis negative direction side. The hole 53E extends from a portion of the right side surface 506 that is positioned on the Z-axis negative direction side with respect to the central axis O to the X-axis negative direction side and the Z-axis positive direction side. On the Z-axis negative direction side with respect to the central axis O, the hole 53A is positioned at approximately the same position in the X-axis direction as the central axis O, and the holes 53B and 53E are disposed on both sides of the central axis O (the hole 53A) in the X-axis direction. On the Z-axis positive direction side with respect to the central axis O, the holes 53C and 53D are disposed on both sides of the central axis O in the X-axis direction. One end of each of the holes 53A to 53E is opened on an inner peripheral surface of the cam containing hole. The other end of the hole 53A is opened at a portion of the bottom surface 503 that is approximately central in the X-axis direction and located on the Y-axis positive direction side. The other end of the hole 53B is opened on a portion of the left side surface 505 that is located on the Y-axis positive direction side and the Z-axis negative direction side. The other end of the hole 53E is opened on a portion of the right side surface 506 that is located on the Y-axis positive direction side and the Z-axis negative direction side. The other ends of the holes 53C and 53D are opened on the first and second recessed portions 50A and 50B, respectively. More specifically, more than half of each of the other ends of the holes 53C and 53D is opened on the third flat surface portion 509, and a remaining portion thereof is opened on the second flat surface portion 508. The first fluid pool chamber 521 is formed in a region between the holes 53C and 53D in the direction around the central axis O on the Z-axis positive direction side with respect to the cam containing hole. The chamber 521, and the holes 53C and 53D partially overlap each other in the Y-axis direction (as viewed from the X-axis direction). The second fluid pool chamber 522 is formed in a region between the holes 53A and 53B in the direction around the central axis O on the Z-axis negative direction side with respect to the cam containing hole O. The cam containing hole and the second fluid pool chamber 522 are connected to each other via a drain fluid passage.

The rotational driving shaft, which is the rotational shaft and the driving shaft of the pump 2, and a cam unit 2U are contained in the cam containing hole. The rotational driving shaft is fixedly coupled with the rotational shaft of the motor 20 in such a manner that a central axis thereof extends on an extension of the central axis of the rotational shaft of the motor 20, and is rotationally driven by the motor 20. The cam unit 2U is provided on the rotational driving shaft. The pump portions 2A to 2E are each a plunger pump (a piston pump) as a reciprocating pump actuated by the rotation of the rotational driving shaft, and each introduce and discharge the brake fluid as the hydraulic fluid according to a reciprocating movement of a plunger (a piston). The cam unit 2U converts the rotational movement of the rotational driving shaft into the reciprocating movement of the plunger. The individual plungers are disposed around the cam unit 2U, and are each contained in the cylinder containing hole 53. A central axis of the plunger approximately coincides with the central axis of the cylinder containing hole 53, and extends in a radial direction of the rotational driving shaft. In other words, the plungers as many as the number of the cylinder containing holes 53 (five) are provided, and extend radially with respect to the central axis O. These plungers are driven by the same rotational driving shaft and the same cam unit 2U. The brake fluid discharged to the second communication fluid passage by each of the pump portions 2A to 2E is collected into the single discharge fluid passage 13, and is used in common by the two hydraulic circuit systems.

The plurality of valve containing holes 54 each has a bottomed cylindrical shape, and extends in the Y-axis direction to be opened on the back surface 502. The plurality of valve containing holes 54 is arrayed in one row along the Y-axis direction, and is disposed on a Y-axis negative direction side of the housing 5. The cylinder containing holes 53 and the valve containing holes 54 are arranged along the Y-axis direction. The valve containing holes 54 at least partially overlap the cylinder containing holes 53 as viewed from the Y-axis direction. A valve portion of each of the electromagnetic valves 21 and the like is fitted and a valve body thereof is contained in each of the valve containing holes 54. The plurality of sensor containing holes each has a bottomed cylindrical shape having a central axis extending in the Y-axis direction, and is opened on the back surface 502. A pressure-sensitive portion, such as the hydraulic sensors 91, is contained in each of the sensor containing portions. The power source hole 55 has a cylindrical shape, and penetrates through the housing 5 (between the front surface 501 and the back surface 502) in the Y-axis direction. The hole 55 is disposed at a portion of the housing 5 that is approximately central in the X-axis direction and located on the Z-axis positive direction side. The hole 55 is formed in a region between the cylinder containing holes 53C and 53D.

The master cylinder ports 511 each have a bottomed cylindrical shape having a central axis extending in the Y-axis direction, and are opened on portions that are ends portion of the front surface 501 on the Z-axis positive direction side and sandwiched between the recessed portions 50A and 50B. The primary port 511P is disposed on the X-axis positive direction side, and the secondary port 511S is disposed on the X-axis negative direction side. Both the ports 511P and 511S are arranged in the X-axis direction, and sandwich the first fluid pool chamber 521 in the X-axis direction (as viewed from the Y-axis direction). The individual ports 511P and 511S are sandwiched between the first fluid pool chamber 521 and the cylinder containing holes 53D and 53C, respectively, in the direction around the central axis O (as viewed from the Y-axis direction). The wheel cylinder ports 512 each have a bottomed cylindrical shape having a central axis extending in the Z-axis direction, and are opened on a Y-axis negative direction side of the top surface 504 (a position closer to the back surface 502 than to the front surface 501). The ports 512a to 512d are arranged in one row in the X-axis direction. The ports 512a and 512d of the P system are disposed on the X-axis positive direction side, and the ports 512b and 512c of the S system are disposed on the X-axis negative direction side. The port 512a is disposed on the X-axis positive direction side with respect to the port 512d, and the port 512b is disposed on the X-axis negative direction side with respect to the port 512c. The ports 512c and 512d sandwich the intake port 513 (the first fluid pool chamber 521) as viewed from the Y-axis direction. The ports 512 and the first fluid pool chamber 521 partially overlap each other in the Z-axis direction. The first fluid pool chamber 521 is disposed in a region surrounded by the master cylinder ports 511P and 511S and the wheel cylinder ports 512c and 512d. The intake port 513 (the first fluid pool chamber 521) is located inside a quadrilateral defined by connecting the ports 511P, 511S, 512c, and 512d (centers thereof) with line segments, as viewed from the Z-axis direction. The intake port 513 is an opening portion of the first fluid pool chamber 521 on the top surface 504, and is opened on an upper side in the vertical direction. The port 513 is opened at a portion of the top surface 504 that is located on the central side in the X-axis direction and offset toward the Y-axis positive direction (a position closer to the front surface 501 than the wheel cylinder ports 512 are). The port 513 is disposed on the Z-axis positive direction side with respect to the intake portions of the pump portions 2A to 2E. The cylinder containing holes 53C and 53D sandwich the port 513 as viewed from the Y-axis direction. The openings of the cylinder containing holes 53C and 53D and the port 513 partially overlap each other in the Y-axis direction (as viewed from the X-axis direction). The unit first connection port 514 has a bottomed cylindrical shape having a central axis extending in the X-axis direction, and is opened slightly on the Y-axis negative direction side with respect to a center of the right side surface 506 in the Y-axis direction and on the Z-axis positive direction side. The port 514 is opened adjacent to a Y-axis negative direction side of the second recessed portion 50B (the first flat surface portion 507) slightly on the Z-axis negative direction side with respect to the master cylinder ports 511. The unit first connection port 515 has a bottomed cylindrical shape having a central axis extending in the X-axis direction, and is opened slightly on the Y-axis negative direction side with respect to a center of the right side surface 506 in the Y-axis direction and at an approximately central position in the Z-axis direction. The port 515 is opened on the Z-axis negative direction side with respect to the second recessed portion 50B, slightly on the Z-axis positive direction side with respect to the central axis O, and slightly on the Y-axis negative direction side with respect to the port 514. The plurality of fluid passages 11 and the like connect the ports 51, the fluid pool chambers 521 and 522, the cylinder containing holes 53, the valve containing holes 54, and the hydraulic sensor containing holes to one another.

The plurality of fixation holes 56 includes bolt holes for fixing the motor, bolt holes 561 to 564 for fixing the ECU, bolt holes 565 and 566 for fixing the first unit, and bolt holes 567 and 568 and pin holes 569 for fixing the housing. The bolt holes for fixing the motor each have a bottomed cylindrical shape having a central axis extending in the Y-axis direction, and are opened on the front surface 501. The bolt holes 561 to 564 for fixing the ECU each have a cylindrical shape having a central axis extending in the Y-axis direction, and penetrate through the housing 5. The holes 561 and 562 are positioned on the Z-axis negative direction side, and the holes 563 and 564 are positioned on the Z-axis positive direction side. The holes 561 and 562 are positioned at both corner portions sandwiched between the bottom surface 503 and the side surfaces 505 and 506, respectively, and are opened on the front surface 501 and the back surface 502. The holes 563 and 564 are positioned at corner portions sandwiched between the top surface 504 and the second flat surface portions 508 of the recessed portions 50 as viewed from the Y-axis direction, and are opened on the first flat surfaces 507 and the back surface 502. The hole 563 is sandwiched between the ports 512b and 512c and the hole 564 is sandwiched between the ports 512a and 512b in the X-axis direction. The bolt holes 565 and 566 for fixing the first unit each have a bottomed cylindrical shape having a central axis extending in the X-axis direction, and are opened on the right side surface 506. The first hole 565 is opened at a portion of the right side surface 506 that is located slightly on the Y-axis negative direction side and on Z-axis positive direction side. The first hole 565 is opened adjacent to a corner portion sandwiched between the first flat surface portion 507 and the third flat surface portion 509 of the second recessed portion 50B as viewed from the X-axis direction. A position of the first hole 565 in the Z-axis direction is located at an approximately intermediate position between the unit connection ports 514 and 515. A position of the first hole 565 in the Y-axis direction, and a position of the port 514 in the Y-axis direction are approximately the same. The second hole 566 is opened on a portion of the right side surface 506 that is located slightly on the Y-axis negative direction side and on the Z-axis negative direction side. A position of the second hole 566 in the Z-axis direction is located on the Z-axis negative direction side with respect to the opening of the cylinder containing hole 53E, and a position of the second hole 566 in the Y-axis direction is approximately the same as a position of the port 515 in the Y-axis direction. The bolt holes 567 and 568 for fixing the housing each have a bottomed cylindrical shape having a central axis extending in the Y-axis direction, and are opened at portions of the front surface 501 that are located at both ends in the X-axis direction and on the Y-axis negative direction side. The hole 567 on the X-axis negative direction side is located adjacent to the left side surface 505 and sandwiched between the surface 505 and the second fluid pool chamber 522 in the X-axis direction, and is sandwiched between the cylinder containing hole 53B and the bolt hole 561 in the Z-axis direction. The hole 568 on the X-axis positive direction side is located adjacent to the right side surface 506 in the X-axis direction, and is sandwiched between the cylinder containing hole 53E and the bolt hole 562 in the Z-axis direction. The pin holes 569 for fixing the housing each have a bottomed cylindrical shape having a central axis extending in the Z-axis direction, and are opened on a Y-axis negative direction side of the bottom surface 503. The hole 569 includes a first hole 569A opened on approximately a central position of the bottom surface 503 in the X-axis direction, and second and third holes 569B and 569C opened on both sides of the bottom surface 503 in the X-axis direction.

The motor 20 includes a motor housing 200. The motor 20 is disposed and the motor housing 200 is attached on the front surface 501 of the housing 5. The front surface 501 functions as a motor attachment surface. The master cylinder ports 511 are located on the Z-axis positive direction side with respect to the motor housing 200. The motor housing 200 has a bottomed cylindrical shape, and includes a cylindrical portion 201, a bottom portion 202, and a flange portion 203. The cylindrical portion 201 contains a magnet as a stator, a rotor, and the like on an inner peripheral side, if being assumed to be a brushed DC motor by way of example. The rotational shaft of the motor 20 extends on a central axis of the cylindrical portion 201. The bottom portion 202 closes one axial side of the cylindrical portion 201. The flange portion 203 is provided at an end portion of the cylindrical portion 201 on the other axial side (the opening side), and flares radially outwardly from an outer peripheral surface of the cylindrical portion 201. Bolt holes penetrate through the flange portion 203. A bolt b1 is inserted in each of the bolt holes, and the bolt b1 is fastened in the bolt hole of the housing 5 (the front surface 501) for fixation the motor. A conductive member (a power source connector) for power supply is connected to the rotor via a brush. This conductive member is contained (attached) in the power source hole 55, and protrudes from the back surface 502 toward the Y-axis negative direction side.

The ECU 90 is provided integrally with the housing 5. The ECU 90 is disposed and attached on the back surface 502 of the housing 5. The ECU 90 includes a control board and a case (a control unit housing) 901. The control board controls states of power supply to the motor 20 and the solenoids of the electromagnetic valves 21 and the like. The control board is contained in the case 901. The case 901 is attached on the back surface 502 (the bolt holes 561 to 564) of the housing 5 with use of bolts b2. The back surface 502 functions as a case attachment surface. The bolt holes 561 to 564 function as a fixation portion for fixing the ECU 90 to the housing 5. Head portions of the bolts b2 are disposed on the front surface 501 side. Shaft portions of the bolts b2 penetrate through the bolt holes 561 to 564, and male screws on distal end sides of the shaft portions are threadably engaged with female screws on the case 901 side. The case 901 is fixedly fastened to the back surface 502 of the housing 5 with the aid of axial forces of the bolts b2. The head portions of the bolts b2 protrude in the first recessed portion 50A and the second recessed portion 50B, respectively. The head portions are contained inside the recessed portions 50. Illustration of the bolts b2 on the Z-axis negative direction side is omitted in FIGS. 7 to 9. The case 901 is a cover member made from a resin material, and includes a board containing portion 902 and a connector portion 903. The board containing portion 902 contains the control board and parts of the solenoids of the electromagnetic valves 21 and the like (hereinafter referred to as the control board and the like). The board containing portion 902 includes a cover portion 902a. The cover portion 902a covers the control board and the like and isolates them from outside. The control board is mounted on the board containing portion 902 generally in parallel with the back surface 502. Terminals of the solenoids of the electromagnetic valves 21 and the like, terminals of the hydraulic sensors 91 and the like, and the conductive member from the motor 20 protrude from the back surface 502. The above-described terminals and conductive member extend toward the Y-axis negative direction side to be connected to the control board. The connector portion 903 is disposed on the X-axis negative direction side with respect to the above-described terminals and conductive member in the board containing portion 902, and protrudes toward a Y-axis positive direction side of the board containing portion 902. The connector portion 903 is disposed on a slightly outer side (the X-axis negative direction side) with respect to the left side surface 505 of the housing 5 as viewed from the Y-axis direction. A terminal of the connector portion 903 is exposed toward the Y-axis positive direction side, and also extends toward the Y-axis negative direction side to be connected to the control board. Each terminal of the connector portion 903 (which is exposed toward the Y-axis positive direction side) is connectable to an external device including the stroke sensor 94 and a fluid level sensor of the reservoir tank 8. Electric connections are realized between the external devices and the control board (the ECU 90) by insertion of another connector connected to these external devices from the Y-axis positive direction side into the connector portion 903. Further, power is supplied from an external power source (a battery) to the control board via the connector portion 903. The above-described conductive member functions as a connection portion that electrically connects the control board and the motor 20 (the rotor thereof) to each other, and power is supplied from the control board to the motor 20 via the above-described conductive member.

The first unit 1A is disposed and attached on the right side surface 506 of the housing 5. The right side surface 506 functions as a first unit attachment surface. In the first unit 1A, the axial direction of the housing 3 (the stroke simulator 4) approximately coincides with the Z-axis direction, and the plug member 48 is located on the Z-axis negative direction side. The Z-axis direction approximately coincides with an actuation axis direction, which is a direction in which the piston 41 moves, and approximately coincides with a longitudinal direction of the right side surface 506. The end of the housing 3 of the first unit LA on the Z-axis positive direction is positioned slightly on the Z-axis negative direction side with respect to the end of the housing 5 of the second unit 1B in the Z-axis positive direction (the top surface 504). The end of the housing 3 in the Z-axis negative direction is positioned slightly on the Z-axis negative direction side with respect to the end of the housing 5 in the Z-axis negative direction (the bottom surface 503), and is positioned slightly on the Z-axis positive direction side with respect to the end of the second unit 1B (the ECU 90) in the Z-axis negative direction. The end of the first unit 1A (including the bleeder valve BV) in the Y-axis positive direction is positioned on the Y-axis positive direction side with respect to the end of the housing 5 in the Y-axis positive direction (the front surface 501), and is positioned on the Y-axis negative direction side with respect to the end of the second unit 1B (the motor housing 200) in the Y-axis positive direction (the bottom portion 202). The end of the housing 3 in the Y-axis negative direction is positioned slightly on the Y-axis positive direction side with respect to the end of the housing 5 in the Y-axis negative direction (the back surface 502). When being viewed from the X-axis direction, the housing 3 (the stroke simulator 4) (a portion thereof including the small-diameter portion 31, the intermediate portion 32, the large-diameter portion 33, and the end portion 34) is positioned between the front surface 501 of the housing 5 and the bottom portion 202 of the motor housing 200. When being viewed from the Y-axis direction, the housing 3 (the stroke simulator 4) (the portion thereof including the small-diameter portion 31, the intermediate portion 32, the large-diameter portion 33, and the end portion 34), and the front surface 501 overlap each other.

Surfaces 381 to 383 of the housing 3 are in abutment with the right side surface 506 of the housing 5. As viewed from the X-axis direction (an axial direction of the connection port 306), the unit first connection port 514 and the simulator first connection port 306A overlap each other, and the unit second connection port 515 and the simulator second connection port 306B overlap each other in such a state that a central axis of the bolt hole 391 of the first flange portion 351 and a central axis of the bolt hole 565 of the housing 5 are generally in alignment with each other and a central axis of the bolt hole 392 of the second flange portion 352 and a central axis of the bolt hole 566 of the housing 5 are generally in alignment with each other. Due to the overlap of the former pair, the port 306A is connected to the positive pressure fluid passage 16 (the port 514) opened on the outer surface of the housing 5. Due to the overlap of the latter pair, the port 306B is connected to the back-pressure fluid passage 17 (the port 515) opened on the outer surface of the housing 5. In this state, the housing 3 is fixed to the right side surface 506 of the housing 5. The first and second flange portions 351 and 352 are fixed to the housing 5 with use of bolts b3. Head portions of the bolts b3 are disposed on X-axis positive direction sides of the first and second flange portions 351 and 352. Shaft portions of the bolts b3 penetrate through the bolt holes 391 and 392, and male screws on distal end sides of the shaft portions are threadably engaged with female screws of the bolt holes 565 and 566 of the housing 5. The flange portions 351 and 352 are fixedly fastened to the right side surface 506 between the head portions of the bolts b3 and the right side surface 506 of the housing 5 due to axial forces of the bolts b3. The bolt holes 565 and 566 function as a fixation portion for fixing the first unit 1A (the housing 3) to the second unit 1B (the housing 5). A leak of the brake fluid outward from the opening portion of the port 306, 514, or 515 via a space between the surface 381 or 382 and the right side surface 506 is prevented or reduced with the aid of a close contact between each of the surfaces 381 and 382, and 506 due to axial forces of the bolts b2. The first flange portion 351 is provided integrally with the fluid passage portions 361 and 362. Therefore, fixing the first flange portion 351 to the housing 5 can more efficiently strengthen the connections between the ports 306A and 306B and the ports 514 and 515. Further, the second flange portion 352 is provided at a position of the housing 3 (the stroke simulator 4) axially separated from the first flange portion 351. Therefore, the axially elongated housing 3 can be attached to the housing 5 with enhanced strength. A space may be generated between the surface 383 of the first flange portion 351 and the right side surface 506. Further, a gasket (a seal member) may be provided between the surface(s) 381 and/or 382 and the right side surface 506. For example, an O-ring may be set on the surface 381 or 382 or the right side surface 506 so as to surround the opening portion of the port 306, 514, or 515. Alternatively, a sheet-like gasket may be disposed between the surface 381 or 382 and the right side surface 506. A member disposed therebetween is not limited to the gasket, and a member including a fluid passage connecting the ports 306 and 514 (515) to each other may be disposed therebetween.

A mount supporting the housing 5 is a base formed by folding and bending a metallic plate, and is fixed to the vehicle body side (normally, a mounting member provided on a bottom surface or a side wall in the engine room) with use of a bolt or the like. The mount includes a first mount portion disposed generally in parallel with the bottom surface 503 and a second mount portion disposed generally in parallel with the front surface 501. Pins are press-fitted and fixed in the pin holes 569 of the housing 5. Each of the pins protruding from the bottom surface 503 is inserted in a hole of the first mount portion. An insulator is set between an inner periphery of this hole and an outer peripheral surface of the pin. The insulator is an elastic member for preventing or reducing (insulating) a vibration, and is made from a rubber material. The pin fixes the bottom surface 503 to the first mount portion via the insulator. The pin is a structure supporting the housing 5 (the bottom surface 503), and functions as a support portion of the bottom surface 503. Any of the first to third pins 569A to 569C may be used. Bolts are inserted and fixed in the bolt holes 567 and 568 of the housing 5. Each of the bolts protruding from the front surface 501 is inserted in a cutout portion of the second mount portion. An insulator is set between an inner periphery of the cutout portion and an outer peripheral surface of the bolt. The bolt fixes the front surface 501 to the second mount portion via the insulator. The bolt and the like are a structure supporting the housing 5 (the front surface 501), and function as a support portion of the front surface 501. The holes 567 to 569 function as a fixation portion for fixing the housing 5 to the vehicle body side (the mount). The mount may include a third mount portion disposed generally in parallel with the right side surface 506 of the housing 5 (adjacent to the X-axis positive direction side of the first unit LA). In this case, the first unit 1A may include a bolt hole on an end surface of the housing 3 (for example, the second fluid passage portion 362) in the X-axis positive direction, and may be fixed to the third mount portion via a bolt inserted in this bolt hole.

Next, a configuration of the third unit 1C will be described. As illustrated in FIG. 2, the third unit 1C includes the housing 6, the master cylinder 7, the reservoir tank 8, and the stroke sensor 94. Hereinafter, an x axis extending in an axial direction of the master cylinder 7 is set, and a positive direction is defined to be the master cylinder 7 side with respect to the brake pedal BP, for convenience of the description. The housing 6 contains the master cylinder 7 therein. A cylinder 60, replenishment ports 62, and supply ports 63 are formed inside the housing 6. The cylinder 60 has a bottomed cylindrical shape extending in the x-axis direction, and is closed and opened on an x-axis positive direction side and an x-axis negative direction side thereof, respectively. The cylinder 60 includes a small-diameter portion 601 and a large-diameter portion 602 on the x-axis positive direction side and the x-axis negative direction side thereof, respectively. The small-diameter portion 601 includes two seal grooves 603 and 604 and one port 605 for each of the P system and the S system. The seal grooves 603 and 604 and the port 605 each have an annular shape extending in a direction around a central axis of the cylinder 60. The port 605 is disposed between the grooves 603 and 604. The replenishment port 62 extends from the port 605, and is opened on an outer surface of the housing 6. The supply port 63 extends from the small-diameter portion 601 of the cylinder 60, and is opened on the outer surface of the housing 6. The other end of the primary pipe 10MP is connected to the supply port 63P, and the other end of the secondary pipe 10MS is connected to the supply port 63S. As illustrated in FIG. 1, a plate-like flange portion 64 is provided on an outer periphery of the housing 6 at a position between the small-diameter portion 601 and the large-diameter portion 602. The flange portion 64 is fixed to a dash board on the vehicle body side with use of a bolt.

The master cylinder 7 is a second hydraulic source capable of supplying the hydraulic pressures to the wheel cylinders W/C, and is connected to the brake pedal BP via the push rod PR and actuated according to the operation performed by the driver on the brake pedal BP. The master cylinder 7 includes pistons 71 and springs 72. The master cylinder 7 is a tandem-type cylinder, and includes a primary piston 71P connected to the push rod RP and a secondary piston 71S configured as a free piston in series as the pistons 71. The pistons 71 are contained in the cylinder 60, and define hydraulic chambers 70. The pistons 71P and 71S each have a bottomed cylindrical shape, and are movable in the x-axis direction along the inner peripheral surface of the small-diameter portion 601 according to the operation on the brake pedal BP. The pistons 71 each include a first recessed portion 711 and a second recessed portion 712 including a bottom portion formed by a partition wall 710. The first recessed portion 711 is disposed on the x-axis positive direction side, and the second recessed portion 712 is disposed on the x-axis negative direction side. A hole 713 penetrates through a circumferential wall of the first recessed portion 711. In the small-diameter portion 601, a primary chamber 70P is defined between the primary piston 71P (the first recessed portion 711P) and the secondary piston 71S (the second recessed portion 712S), and a secondary chamber 70S is defined between the secondary piston 71S (the first recessed portion 711S) and an end portion of the small-diameter portion 601 in the x-axis positive direction. The supply fluid passages 63P and 63S are constantly opened to the individual chambers 70P and 70S, respectively. Focusing on the primary piston 71P, an end portion of the push rod PR in the x-axis positive direction is contained in the second recessed portion 712P, and is in abutment with the partition wall 710P. The stroke sensor 94 includes a magnet and a sensor main body (a Hall element or the like). The magnet is provided on the primary piston 71P, and the sensor main body is attached on the outer surface of the housing 6. A flange portion PR1 is provided on the push rod PR. A movement of the push rod PR toward the x-axis negative direction side is regulated by abutment between a stopper portion 600 provided at the opening portion of the cylinder 60 (the large-diameter portion 602) and the flange portion PR1.

The springs 72P and 72S are coil springs as elastic members. Units of the springs 72P and 72S each including a retainer member and a stopper member, similarly to the spring unit in the stroke simulator 4, are set in the primary chamber 70P and the secondary chamber 70S, respectively. The unit of the spring 72P is set between the partition wall 710P and the partition wall 710S. The unit of the spring 72S is set between an end potion of the small-diameter portion 601 in the x-axis positive direction and the partition wall 710S. The springs 72 function as return springs constantly biasing the pistons 71 toward the x-axis negative direction side. Cup-like seal members 731 and 732 are set in the seal grooves 603 and 604, respectively. Lip portions of the seal members 731 and 732 are in sliding contact with outer peripheral surfaces of the pistons 71. On the primary side, the seal member 731P on the x-axis negative direction side prohibits a flow of the brake fluid directed from the x-axis positive direction side (the port 605P) toward the x-axis negative direction side (the large-diameter portion 602). The seal member 732P on the x-axis positive direction side prohibits a flow of the brake fluid directed toward the x-axis negative direction side (the port 605P), and permits a flow of the brake fluid directed toward the x-axis positive direction side (the primary chamber 70P). On the secondary side, the seal member 731S on the x-axis negative direction side prohibits a flow of the brake fluid directed from the x-axis negative direction side (the primary chamber 70P) toward the x-axis positive direction side (the port 605S). The seal member 732S on the x-axis positive direction side prohibits a flow of the brake fluid directed toward the x-axis negative direction side (the port 605S), and permits a flow of the brake fluid directed toward the x-axis positive direction side (the secondary chamber 70S). The holes 713 are each positioned between portions where both the seal members 731 and 732 (the lip portions) and the outer peripheral surface of the piston 71 are in contact with each other (one side closer to the seal member 732) in an initial state, in which both the pistons 71P and 71S are maximally displaced toward the x-axis negative direction side.

The reservoir tank 8 is a brake fluid source storing the brake fluid therein, and is a low-pressure portion opened to an atmospheric pressure. The reservoir tank 8 is set on a Z-axis positive direction side of the housing 6. A bottom portion side (a Z-axis negative direction side) of the reservoir tank 8 is divided into three chambers 83 by a first partition wall 821 and a second partition wall 822. The first chambers 83P and 83S are connected to the replenishment ports 62P and 62S of the housing 6, respectively. A supply port 81 is opened to the second chamber 83R. The other end of the intake pipe 10R is connected to the supply port 81 via a nipple 10R1.

Next, a control configuration will be described. The ECU 90 of the second unit 1B receives inputs of the values detected by the stroke sensor 94 and the hydraulic sensors 91 and the like, and information regarding a running state from the vehicle side, and controls the opening/closing operations of the electromagnetic valves 21 and the like and the number of rotations of the motor 20 (i.e., the discharge amount of the pump 2) based on a program installed therein, thereby controlling the wheel cylinder hydraulic pressure (the hydraulic braking force) in each of the wheels W. By this control, the ECU 90 performs various kinds of brake control (anti-lock brake control for preventing or reducing a slip of the wheel W due to the braking, boosting control for reducing a required driver's brake operation force, brake control for controlling a motion of the vehicle, autonomous brake control such as adaptive cruise control, regenerative cooperative brake control, and the like). The control of the motion of the vehicle includes vehicle behavior stabilization control such as electronic stability control. In the regenerative cooperative brake control, the ECU 90 controls the wheel cylinder hydraulic pressures so as to achieve a target deceleration (a target braking force) in cooperation with regenerative brake.

The ECU 90 includes a brake operation amount detection portion 90a, a target wheel cylinder hydraulic pressure calculation portion 90b, a pressing force brake creation portion 90c, a boosting control portion 90d, and a control switching portion 90e. The stroke sensor 94 detects the stroke of the primary piston 71P (the pedal stroke). The brake operation amount detection portion 90a detects a displacement amount (the pedal stroke) of the brake pedal BP as the brake operation amount by receiving the input of the value detected by the stroke sensor 94. The target wheel cylinder hydraulic pressure calculation portion 90b calculates a target wheel cylinder hydraulic pressure. More specifically, the target wheel cylinder hydraulic pressure calculation portion 90b calculates a target wheel cylinder hydraulic pressure that realizes a predetermined boosting ratio, i.e., an ideal characteristic about a relationship between the pedal stroke and a brake hydraulic pressure requested by the driver (a vehicle deceleration requested by the driver) based on the detected pedal stroke. Further, at the time of the regenerative cooperative brake control, the target wheel cylinder hydraulic pressure calculation portion 90b calculates the target wheel cylinder hydraulic pressure in relation to the regenerative braking force. For example, the target wheel cylinder hydraulic pressure calculation portion 90b calculates such a target wheel cylinder hydraulic pressure that a sum of the regenerative braking force input from a control unit of a regenerative braking apparatus of the vehicle and a hydraulic braking force corresponding to the target wheel cylinder hydraulic pressure can satisfy the vehicle deceleration requested by the driver. At the time of the motion control, the target wheel cylinder hydraulic pressure calculation portion 90b calculates the target wheel cylinder hydraulic pressure for each of the wheels W so as to realize a desired vehicle motion state based on, for example, a detected vehicle motion state amount (a lateral acceleration or the like). The pressing force brake creation portion 90c deactivates the pump 2, and controls the shut-off valves 21, the SS/V IN 28, and the SS/V OUT 29 in opening directions, a closing direction, and a closing direction, respectively. The boosting control portion 90d actuates the pump 2, and controls the shut-off valves 21 and the communication valves 23 in closing directions and opening directions, respectively, when the brake operation is performed by the driver.

Further, the ECU 90 includes a sudden brake operation state determination portion 90f and a second pressing force brake creation portion 90g. The sudden brake operation state determination portion 90f detects a brake operation state based on an input from the brake operation amount detection portion 90a or the like, and determines whether the brake operation state is a predetermined sudden brake operation state. For example, the sudden brake operation state determination portion 90f determines whether an amount of a change in the pedal stroke per unit time exceeds a predetermined threshold value. When the brake operation is determined to be the sudden brake operation state, the control switching portion 90e switches control so as to create the wheel cylinder hydraulic pressures by the second pressing force brake creation portion 90. The second pressing force brake creation portion 90g activates the pump 2 and controls the shut-off valves 21, the SS/V IN 28, and the SS/V OUT 29 in the closing directions, the opening direction, and the closing direction, respectively. After that, when the brake operation state starts to be determined not to be the sudden brake operation state and/or a predetermined condition indicating that a discharge capacity of the pump 2 becomes sufficient is satisfied, the control switching portion 90e switches the control so as to create the wheel cylinder hydraulic pressures by the boosting control portion 90d. In other words, the control switching portion 90e controls the SS/V IN 28 and the SS/V OUT 29 in the closing direction and the opening direction, respectively.

Next, functions will be described.

### (Hydraulic Control Function)

The second unit 1B can supply the master cylinder pressure to each of the wheel cylinders W/C. The fluid passage system (the supply fluid passages 11 and the like) connecting the hydraulic chambers 70 of the master cylinder 7 and the wheel cylinders W/C to each other with the shut-off valves 21 controlled in the opening directions by the pressing force creation portion 90c realizes the pressing force brake that creates the wheel cylinder hydraulic pressures by the master cylinder pressure generated with use of the pedal pressing force (non-boosting control). Each of the hydraulic chambers 70P and 70S is replenished with the brake fluid from the reservoir tank 8, and also generates the hydraulic pressure (the master cylinder hydraulic pressure) by the movement of the piston 71. The brake fluid transmitted out of the master cylinder 7 according to the brake operation performed by the driver is delivered into the master cylinder pipes 10M, and is introduced into the supply fluid passages 11 of the second unit 1B via the master cylinder ports 511. The pressures in the wheel cylinders W/C (FL) and W/C (RR) are increased with use of the master cylinder pressure generated in the primary chamber 70P via the fluid passage (the supply fluid passage 11P) of the P system. Further, the pressures in the wheel cylinders W/C (FR) and W/C (RL) are increased with use of the master cylinder pressure generated in the secondary chamber 70S via the fluid passage (the supply fluid passage 11S) of the S system. The third unit 1C does not include a negative pressure booster that boosts the brake operation force input by the driver with use of a negative pressure generated by an engine of the vehicle or an additionally provided negative pressure pump. The SS/V OUT 29 is controlled in the closing direction, which prohibits the stroke simulator 4 from functioning. More specifically, the piston 41 is prohibited from being activated, which stops the inflow of the brake fluid from the hydraulic chamber 70 (the secondary chamber 70S) into the positive pressure chamber 401. This allows the wheel cylinder hydraulic pressure to be further efficiently increased. The SS/V IN 28 may be controlled in the opening direction.

The second unit 1B can control the hydraulic pressure in each of the wheel cylinders W/C individually with use of the hydraulic pressure generated by the pump 2 independently of the brake operation performed by the driver. When the shut-off valves 21 are controlled in the closing directions, the communication between the master cylinder 7 and the wheel cylinders W/C is blocked, and, along therewith, the second unit 1B is brought into a state capable of creating the wheel cylinder hydraulic pressures with use of the pump 2. The second unit 1B supplies the brake fluid pressurized by the pump 2 to the brake actuation units via the wheel cylinder pipes 10W, thereby generating the brake hydraulic pressures (the wheel cylinder hydraulic pressures). The brake system connecting the first fluid pool chamber 521 and the wheel cylinders W/C to each other (the intake fluid passage 12, the discharge fluid passage 13, and the like) functions as a so-called brake-by-wire system that creates the wheel cylinder hydraulic pressures by the hydraulic pressure generated with use of the pump 2, thereby realizing the boosting control, the regenerative cooperative control, and the like. The boosting control portion 90d performs boosting control of generating a hydraulic braking force by which the brake operation force input by the driver is insufficient. More specifically, the boosting control portion 90d realizes the target wheel cylinder hydraulic pressure by controlling the pressure adjustment valve 24 while keeping the pump 2 activated at a predetermined number of rotations to thus adjust the brake fluid amount to be supplied from the pump 2 to the wheel cylinders W/C. In other words, the brake system 1 exerts a boosting function that assists the brake operation force by activating the pump 2 of the second unit 1B instead of the engine negative pressure booster. Further, the boosting control portion 90d controls the SS/V IN 28 and the SS/V OUT 29 in the closing direction and the opening direction, respectively. By this control, the boosting control portion 90d causes the stroke simulator 4 to function.

The brake fluid flows from the master cylinder 7 into the positive pressure chamber 401 of the stroke simulator 4 according to the brake operation performed by the driver, by which the pedal stroke is generated, and the reaction force (the pedal reaction force) of the brake operation performed by the driver is also generated due to the biasing force of the elastic member. The brake fluid transmitted out of the secondary chamber 70S according to the brake operation performed by the driver is delivered into the secondary pipe 10MS, and is introduced into the positive fluid passage 16 via the supply fluid passage 11S of the second unit 1B. The positive pressure fluid passage 16 is connected to the positive pressure chamber 401 via the unit first connection port 514, the simulator first connection port 306A of the first unit 1A, and the first connection fluid passage 304. The positive pressure chamber 401 has a cylindrical shape, and a radial cross-sectional area thereof is larger than a flow passage cross-sectional area of the first connection fluid passage 304 opened to the positive pressure chamber 401. The positive pressure chamber 401 is a volume chamber above the first connection fluid passage 304. When a hydraulic pressure (the master cylinder pressure) equal to or higher than a predetermined pressure is applied to a pressure-receiving surface of the piston 41 in the positive pressure chamber 401, the piston 41 is axially moved toward the back-pressure chamber 402 side while pressing and compressing the spring 431 and the like. At this time, the volume of the positive pressure chamber 401 increases, and, at the same time, the volume of the back-pressure chamber 402 reduces. As a result, the brake fluid transmitted out of the secondary chamber 70S is delivered into the positive pressure chamber 401. At the same time, the brake fluid is transmitted out of the back-pressure chamber 402, and the brake fluid in the back-pressure chamber 402 is discharged. The back-pressure chamber 402 has a cylindrical shape, and a radial cross-sectional area thereof is larger than a flow passage cross-sectional area of the second connection fluid passage 305 opened to the back-pressure chamber 402. The back-pressure chamber 402 is a volume chamber above the second connection fluid passage 305. The back-pressure chamber 402 is connected to the back-pressure fluid passage 17 via the second connection fluid passage 305, the simulator second connection port 306B, and the unit second connection port 515 of the second unit 1B. The brake fluid transmitted out of the back-pressure chamber 402 according to the brake operation performed by the driver is introduced into the fluid passage 17. The stroke simulator 4 introduces therein the brake fluid from the master cylinder 7 in this manner, thereby simulating hydraulic stiffness of the wheel cylinders W/C to thus imitate a feeling that the driver would have when pressing the pedal. When the pressure in the positive pressure chamber 401 reduces to lower than the predetermined pressure, the piston 41 is returned to an initial position due to the biasing force (an elastic force) of the spring 431 and the like. When the piston 41 is located at the initial position, a first space in the Z-axis direction is generated between the first damper 471 and the head portion 451 of the stopper member 45, and a second space in the Z-axis direction is generated between the second damper 472 and the bottom portion 461 of the seat member 46. When the first spring 431 is compressed by a distance equal to or longer than the first space in the Z-axis direction according to the stroke of the piston 41 toward the Z-axis negative direction side, the first damper 471 starts to be elastically deformed by being sandwiched between the protrusion portion 413 and the head portion 451. When the second spring 432 is compressed by a distance equal to or longer than the second space in the Z-axis direction, the second damper 472 starts to be elastically deformed by contacting the bottom portion 461. These operations help a reduction in the impact, and further make adjustable a characteristic about a relationship between the pedal pressing force (the pedal reaction force) and the pedal stroke. Therefore, the pedal feeling can be improved.

The SS/V OUT 29, the SS/V IN 28, and the check valve 280 adjust the flow of the brake fluid introduced from the back-pressure chamber 402 into the back-pressure fluid passage 17. These valves permit or prohibit the inflow of the brake fluid from the master cylinder 7 into the stroke simulator 4 (the positive pressure chamber 401) by permitting or prohibiting the brake fluid introduced into the fluid passage 17 to be delivered or from being delivered toward any of the low-pressure portions (the first fluid pool chamber 521 and the wheel cylinders W/C). By this operation, the activation of the stroke simulator 4 is adjusted. The valves 29 and 28 function as a switching electromagnetic valve that switches presence or absence of the inflow of the hydraulic fluid into the stroke simulator 4. Further, the valves 29, 28, and 280 function as a switching portion that switches a supply destination (an outflow destination) of the brake fluid introduced into the fluid passage 17 between the first fluid pool chamber 521 and the wheel cylinders W/C.

The second pressing force brake creation portion 90g realizes second pressing force brake that creates the wheel cylinder hydraulic pressures with use of the brake fluid transmitted out of the back-pressure chamber 402 until the pump 2 is ready to generate sufficiently high wheel cylinder pressures. More specifically, the SS/V OUT 29 is controlled in the closing direction. By this operation, the brake fluid introduced from the back-pressure chamber 402 into the back-pressure fluid passage 17 is delivered toward the supply fluid passages 11 by passing through the SS/V IN 28 (the first simulator fluid passage 18) and the check valve 280 (the bypass fluid passage 180). In other words, the supply destination of the brake fluid introduced into the back-pressure chamber 17 is switched to the wheel cylinders W/C. Therefore, the brake system 1 can ensure responsiveness in terms of increasing the wheel cylinder hydraulic pressures. When the pressure on the wheel cylinder W/C side exceeds the pressure on the back-pressure chamber 402 side, the check valve 280 is automatically brought into a closed state, which prohibits a reverse flow of the brake fluid from the wheel cylinder W/C side to the back-pressure chamber 402 side. The shut-off valves 21 may be controlled in the opening directions. Further, the SS/V IN 28 may be controlled in the closing direction, and, in this case, the brake fluid from the back-pressure chamber 402 is supplied to the wheel cylinder W/C side by passing through the check valve 280 (brought into a opened state because the pressure in the wheel cylinder W/C side is still lower than the back-pressure chamber 402 side). In the present embodiment, the brake fluid can be efficiently supplied from the back-pressure chamber 402 side to the wheel cylinder W/C side by controlling the SS/V IN 28 in the opening direction.

When the brake operation state is determined to be the sudden brake operation state, the control switching portion 90e controls the SS/V OUT 29 in the closing direction to switch the supply destination of the brake fluid to the wheel cylinders W/C. Therefore, the second pressing force brake can be correctly realized in a situation requiring the responsiveness in terms of increasing the wheel cylinder hydraulic pressures. The pump 2 is a reciprocating pump, and therefore has relatively high responsiveness. Therefore, it takes a relatively short time for the pump 2 to become ready to generate the sufficient wheel cylinder pressures since the pump 2 starts the activation, which allows the second pressing force brake to be activated in a shorter time period. A gear pump may be used as the pump 2. Upon satisfaction with the predetermined condition indicating that the discharge capacity of the pump 2 becomes sufficient, the control switching portion 90e controls the SS/V OUT 29 in the opening direction. By this operation, the brake fluid introduced from the back-pressure chamber 402 into the back-pressure fluid passage 17 is delivered toward the first fluid pool chamber 521 by passing through the SS/V OUT 29 (the second simulator fluid passage 19). In other words, the supply destination of the brake fluid transmitted out of the back-pressure chamber 402 is switched to the first fluid pool chamber 521. Therefore, the stroke simulator 4 is actuated, and an excellent pedal feeling can be ensured. Even in a case of occurrence of such a failure that the SS/V OUT 29 is stuck in the closed state while the stroke simulator 4 is in operation, the piston 41 can return to the initial position due to the supply of the brake fluid from the first fluid pool chamber 521 side to the back-pressure chamber 402 by passing through the check valve 290.

(Reservoir Function)

The first fluid pool chamber 521 is replenished with the brake fluid from the reservoir tank 8 via the intake pipe 10R, and also functions as the reservoir (an internal reservoir) to supply the brake fluid to the intake portion of each of the pump portions 2A to 2E. Each of the pump portions 2A to 2E introduces and discharges the brake fluid via the first fluid pool chamber 521. When the brake fluid leaks from the intake pipe 10R due to, for example, detachment of the pipe 10R from the nipple 10R1 or 10R2 or loosening of a band fastening the pipe 10R to the nipple 10R1 or 10R2, the first fluid pool chamber 521 functions as the reservoir storing the brake fluid therein. The pump 2 can generate the wheel cylinder hydraulic pressures and can generate a braking torque on the vehicle on which the brake system 1 is mounted by introducing the brake fluid from the first fluid pool chamber 521 and discharging the brake fluid. When the fluid leaks from the pipe 10R, the brake system 1 can continuously realize the pressing force brake because being able to secure the brake fluid in the first chambers 83P and 83S although the brake fluid reduces in the second chamber 83R of the reservoir tank 8. With the first fluid pool chamber 521 disposed on the upper side in the vertical direction with respect to the intake portions of the pump portions 2A to 2E, the brake fluid can be easily supplied from the first fluid pool chamber 521 to each of the intake portions via the intake fluid passage 12 with the aid of a weight of the brake fluid itself. Further, the brake system 1 prevents or reduces retention of air inside the intake fluid passage 12, thereby preventing or reducing an intake of air (air bubbles) by the pump 2. The intake port 513 may be opened on the surface 501 or the like other than the top surface 504. In the present embodiment, the intake port 513 is opened on the top surface 504. Therefore, since the first fluid pool chamber 521 is disposed on the upper side in the vertical direction with respect to the housing 5, the first fluid pool chamber 521 can be easily disposed on the upper side in the vertical direction with respect to the intake portion of each of the pump portions 2A to 2E.

(Pump Function)

The pump 2 includes the plurality of pump portions 2A to 2E. The central axes of the two pump portions 2A and 2C or the like opposite of the central axis O from each other are not located on the same straight line, and form an angle larger than 0 degrees. Therefore, respective intake/discharge strokes of the pump portions 2A to 2E are not synchronized and out of phase with one another. This allows periodic changes (pulse pressures) of respective discharge pressures of the pump portions 2A to 2E to reduce each other, and therefore can reduce a pulse pressure as the entire pump 2. The plurality of pump portions 2A to 2E is disposed at generally even intervals in the circumferential direction. Therefore, the brake system 1 can reduce a change as large as a sum of the discharge pressures of the plurality of pump portions 2A to 2E as much as possible as the entire pump 2 by causing the pump portions 2A to 2E to operate with intake/discharge strokes having generally even phase shifts among them. Therefore, the brake system 1 can acquire a further high effect of reducing the pulse pressure. The number of pump portions 2A to 2E may be an even number. In the present embodiment, the above-described number is an odd number equal to or larger than three. Therefore, compared to when the above-described number is an even number, the brake system 1 can easily reduce the strength of the pulse pressure (a width of the change) as the entire pump 2 by shifting the phases while disposing the plurality of pump portions 2A to 2E at the generally even intervals in the circumferential direction, thereby noticeably acquiring the effect of reducing the pulse pressure. The number of pump portions 2A to 2E is not limited to five, and may be, for example, three. In the present embodiment, the above-described number is five. Therefore, compared to when the above-described number is three, the brake system 1 can improve the effect of reducing the pulse pressure to thus acquire sufficient quietness, and can also ensure a sufficient discharge amount as the entire pump 2 while preventing or cutting down an increase in the size of the second unit 1B by reducing the size of each of the pump portions 2A to 2E. Further, compared to when the above-described number is six or more, the brake system 1 cuts down the increase in the number of pump portions 2A to 2E, thereby being advantageous in terms of a layout and the like and easily achieving a reduction in the size of the second unit 1B.

(Drain Function)

The brake fluid leaking out from each of the cylinder containing holes to the cam containing hole is introduced into the second fluid pool chamber 522 via the drain fluid passage and is stored in the chamber 522. Therefore, the brake system 1 can prevent or reduce entry of the brake fluid located in the cam containing hole into the motor 20, thereby improving operability of the motor 20. The opening of the chamber 522 is closed by a cover member.

### (Air Removal Function)

The second bleeder portion 372 and the second bleeder valve BV2 are provided on the back-pressure chamber 402 side. The fluid passages 17 and 18 and the like connected to the back-pressure chamber 402 are also connected to the pump 2 (the discharge portion thereof), and the second unit 1B is provided so as to able to switch the communication state between the pump 2 (the discharge portion thereof) and the back-pressure chamber 402. The pump 2 (the discharge portion thereof) and the back-pressure chamber 402 are brought into communication with each other with the valve BV opened. Then, the brake fluid from the pump 2 is supplied to the back-pressure chamber 402 by actuating the pump 2. Therefore, the brake fluid discharged from the pump 2 pushes out air in the fluid passage 17 and the like and air in the back-pressure chamber 402, by which the air in these locations is discharged from the valve BV together with the above-described air. This operation is continuously performed, which allows the air to be discharged by a large amount, thereby contributing to an effective removal of the air.

(Size Reduction and Improvement of Layout Flexibility)

The brake system 1 includes the first unit 1A, the second unit 1B, and the third unit 1C. Therefore, the system 1 can be mounted on the vehicle with improved mountability. The stroke simulator 4 (the first unit LA) is disposed integrally with the second unit 1B. Therefore, the brake system 1 can prevent or cut down an increase in the size of the third unit 1C compared to when the stroke simulator 4 is disposed on the third unit 1C (the master cylinder 7) side. The brake system 1 includes the stroke simulator 4 provided on a different unit from the master cylinder 7, and therefore can achieve reductions in sizes of components around the brake pedal BP (the third unit 1C). Therefore, even when the master cylinder 7 protrudes toward a driver's seat side at the time of collision of the vehicle, the brake system 1 can reduce an amount of the protrusion. Therefore, the brake system 1 can improve safety regarding collision. This is especially effective for a compact vehicle or the like subject to a limitation on a space around an underside of the driver's seat. The stroke simulator 4 (the first unit LA) is disposed integrally with the second unit 1B. Therefore, the brake system 1 does not have to include a pipe connecting the stroke simulator 4 and the second unit 1B (the positive pressure fluid passage 16) to each other. In other words, the brake system 1 does not have to include a pipe connecting the positive pressure chamber 401 and the second unit 1B to each other. Further, the brake system 1 does not have to include a pipe connecting the back-pressure chamber 402 and the second unit 1B (the back-pressure fluid passage 17) to each other in such a configuration that the brake fluid is transmitted out from the back-pressure chamber 402 according to the movement of the piston 41 due to the brake operation performed by the driver. Therefore, the brake system 1 can reduce the number of pipes as the entire brake system 1, thereby preventing or reducing complication of the system 1, and also preventing or cutting down a cost increase accompanying the increase in the number of pipes.

The electromagnetic valves 21 and the like and the hydraulic sensors 91 and the like (hereinafter referred to as the electromagnetic valves and the like) are disposed on the second unit 1B. The brake system 1 includes main electrically controlled devices provided on the second unit 1B side, and therefore can achieve simplification of the first unit 1A and the third unit 1C. Focusing on the third unit 1C, the brake system 1 includes no electromagnetic valve and the like disposed on the third unit 1C and further requires no ECU for driving the electromagnetic valves on the third unit 1C, and therefore can reduce the size of the third unit 1C and improve a degree of freedom of the layout thereof. Further, the brake system 1 requires no wiring (harness) for controlling the electromagnetic valves and transmitting the signals of the hydraulic sensors between the third unit 1C and the ECU 90 (the second unit 1B). Therefore, the brake system 1 can prevent or reduce complication thereof, and can also prevent or cut down a cost increase accompanying the increase in the number of wirings. The same also applies to the first unit 1A. For example, the second unit 1B includes the switching electromagnetic valve that switches the presence/absence of the inflow of the hydraulic fluid into the stroke simulator 4. In other words, the SS/V IN 28 and the SS/V OUT 29 are disposed on the second unit 1B. The brake system 1 includes the electronically controlled devices regarding the stroke simulator 4 provided on the second unit 1B side, and therefore can achieve the simplification of the first unit 1A. The brake system 1 requires no ECU for switching the activation of the stroke simulator 4 on the first unit 1A, and also requires no wiring (harness) for controlling the SS/V OUT 28 and the like between the first unit 1A and the ECU 90 (the second unit 1B).

The ECU 90 is attached to the housing 5, and the ECU 90 and the housing 5 (containing the electromagnetic valves and the like) are integrated as the second unit 1B. Therefore, the brake system 1 can omit a wiring (a harness) connecting the electromagnetic valves and the like and the ECU 90 to each other. More specifically, the terminals of the solenoids of the electromagnetic valves 21 and the like, and the terminals of the hydraulic sensors 91 and the like are directly connected to the control board (without intervention of a harness and a connector outside the housing 5). Therefore, for example, the brake system 1 can omit a harness connecting the ECU 90 and the SS/V IN 28 and the like to each other. The motor 20 is disposed on the first unit 1B, and the housing 5 (containing the pump 2) and the motor 20 are integrated as the second unit 1B. The second unit 1B functions as a pump device. Therefore, the brake system 1 can omit a wiring (a harness) connecting the motor 20 and the ECU 90 to each other. More specifically, the conductive member for supplying power and transmitting signals to the motor 20 is contained in the power source hole 55 of the housing 5, and is directly connected to the control board (without intervention of a harness and a connector outside the housing 5). The conductive member functions as a connection member connecting the control board and the motor 20 to each other. The housing 5 is sandwiched between the motor 20 and the ECU 90. In other words, the motor 20, the housing 5, and the ECU 90 are disposed so as to be arranged in this order along the axial direction of the motor 20 (the Y-axis direction). More specifically, the ECU 90 is attached on the back surface 502 opposite from the front surface 501 on which the motor 20 is attached. Therefore, the motor 20 and the ECU 90 can be disposed so as to overlap each other as viewed from the motor 20 side or the ECU 90 side (as viewed from the Y-axis direction). As a result, the brake system 1 can reduce the area of the second unit 1B as viewed from the motor 20 side or the ECU 90 side, thereby achieving the reduction in the size of the second unit 1B. The brake system 1 can achieve a reduction in a weight of the second unit 1B due to the reduction in the size of the second unit 1B.

The connector portion 903 of the ECU 90 is adjacent to the surface 505 continuous to the front surface 501 and the back surface 502 of the housing 5. In other words, the connector portion 903 is not covered by the housing 5 and protrudes beyond the surface 505 as viewed from the motor 20 side (Y-axis positive direction side). Therefore, the control board of the ECU 90 can be extended as far as not only a region overlapping the housing 5 but also a region overlapping the connector portion 903 (a region adjacent to the left side surface 505) as viewed from the motor 20 side. The bolts b2 for attaching the ECU 90 to the back surface 502 are not fixed to the housing 5 by penetrating through the ECU 90 from the back surface 502 (the ECU 90) side but are fixed to the ECU 90 by penetrating through the housing 5 from the front surface 501 side. If the bolts b2 penetrate through the ECU 90 (the control board), the control board would be unable to be disposed at portions through which these bolts b2 penetrate. Further, if the control board is also disposed on a back of the connector portion 903, the control board would be unable to be disposed in proximity to the portion through which the bolts b2 penetrate. The incapability to dispose the control board makes it impossible to lay a wiring pattern and mount an element at this portion. In other words, an area where the control board is implemented reduces. Providing the bolts b2 so as to penetrate through the housing 5 without penetrating through the ECU 90 can eliminate a portion where the bolts b2 and the control board would otherwise interfere with each other. Therefore, the brake system 1 can secure a wide area where the control board is implemented, and easily deal with multi-functionalization of the ECU 90.

The terminal of the connector portion 903 extends in the Y-axis direction. Therefore, the brake system 1 can prevent or cut down an increase in the dimension of the second unit 1B (in the X-axis direction) viewed from the Y-axis direction. The terminal of the connector portion 903 is exposed toward the motor 20 side (the Y-axis positive direction side). Therefore, the connector (the harness) connected to the connector portion 903 overlaps the housing 5 and the like in the axial direction of the motor 20 (the Y-axis direction), whereby the brake system 1 can prevent or cut down an increase in a dimension of the second unit 1B including this connector (the harness) in the Y-axis direction (the axial direction of the motor 20). The connector portion 903 extends in a horizontal direction in the state mounted on the vehicle. As a result, the brake system 1 can prevent or reduce entry of water into the connector portion 903 while facilitating the connection of the harness to the connector portion 903. The connector portion 903 is adjacent to the left side surface 505 of the housing 5. Therefore, the brake system 1 can prevent or reduce interference between the connector (the harness) connected to the connector portion 903 and the pipes 10W and 10R connected to the ports 512 and 513 of the top surface 504 compared to when the connector portion 903 is adjacent to the top surface 504. Further, the brake system 1 can prevent or reduce interference between the above-described connector (the harness) and the vehicle body-side member (the mount) facing the bottom surface 503 compared to when the connector portion 903 is adjacent to the bottom surface 503. In other words, the brake system 1 can facilitate the connection of the connector (the harness) to the connector portion 903. Therefore, the brake system 1 can improve mounting workability thereof onto the vehicle.

The first unit 1A is attached on the surface 506 different from the front surface 501 to which the motor 20 is attached on the housing 5. Therefore, the brake system 1 can reduce the area of the front surface 501 to thus achieve a reduction in the size of the housing 5 while preventing or reducing interference between the first unit 1A and the motor 20, compared to when the first unit 1A is attached on the front surface 501. Therefore, the brake system 1 can achieve the reduction in the size of the second unit 1B including the first unit 1A, thereby preventing or reducing imposition of a limitation onto the layout when being mounted on the vehicle. The first unit 1A is attached on the surface 506 different from the back surface 502 on which the ECU 90 is attached on the housing 5. Therefore, the brake system 1 can reduce the area of the back surface 502 to thus achieve the reduction in the size of the housing 5 while preventing or reducing the interference between the first unit 1A and the ECU 90. The first unit 1A is attached on the surface 506 different from the bottom surface 503 which the vehicle body-side member (the mount) faces on the housing 5. Therefore, the brake system 1 can reduce the area of the bottom surface 503 to thus achieve the reduction in the size of the housing 5 while preventing or reducing interference between the first unit 1A and the vehicle body-side member (the mount). The first unit 1A is attached on the surface 506 different from the top surface 504 on which the ports 512 and 513 are opened on the housing 5. Therefore, the brake system 1 can reduce the area of the top surface 504 to thus achieve the reduction in the size of the housing 5 while preventing or reducing interference between the first unit 1A and the pipes 10W and 10R connected to the ports 512 and 513. The first unit 1A is attached on the surface 506 different from the left side surface 505 which the connector portion 903 faces (is adjacent to) on the housing 5. Therefore, the brake system 1 can reduce the area of the left side surface 505 to thus achieve the reduction in the size of the housing 5 while preventing or reducing interference between the first unit 1A and the connector (the harness) connected to the connector portion 903.

The end of the first unit 1A (including the bleeder valve BV) on the Y-axis positive direction side is located on the Y-axis negative direction side with respect to the end of the motor 20 on the Y-axis positive direction side (the bottom portion 202). The brake system 1 can prevent or reduce protrusion of the first unit 1A beyond the motor 20 toward the Y-axis positive direction side, thereby preventing or cutting down the increase in the dimension of the second unit 1B including the first unit 1A and the motor 20 in the Y-axis direction. The housing 3 (the stroke simulator 4) (the portion thereof including the small-diameter portion 31, the intermediate portion 32, the large-diameter portion 33, and the end portion 34) is located on the Y-axis positive direction side with respect to the end of the housing 5 on the Y-axis positive direction side (the front surface 501) and on the Y-axis negative direction side with respect to the end of the motor 20 on the Y-axis positive direction side (the bottom portion 202). The housing 3 (the stroke simulator 4) can be disposed in a space on the X-axis positive direction side of the motor 20. Due to this configuration, the brake system 1 can prevent or cut down the increase in the size of the second unit 1B including the first unit 1A and the motor 20. The housing 3 (the stroke simulator 4) (the portion thereof including the small-diameter portion 31, the intermediate portion 32, the large-diameter portion 33, and the end portion 34) is at least partially located on the X-axis negative direction side with respect to the end of the housing 5 on the X-axis positive direction side (the right side surface 506). Due to this configuration, the housing 3 (the stroke simulator 4) can be disposed in the space located on the X-axis positive direction side with respect to the motor 20 and on the Y-axis positive direction side with respect to the front surface 501. Due to this configuration, the brake system 1 can further prevent or cut down the increase in the size of the second unit 1B including the first unit 1A and the motor 20.

The central axis of the port 306A has an angle (larger than 0 degrees) with respect to (not in parallel with) the central axis of the stroke simulator 4 (the positive pressure chamber 401), and extends in a direction bent with respect to the central axis of the stroke simulator 4. Therefore, the brake system 1 can avoid mounting of the first unit 1A onto the housing 5 in such a manner that the central axis of the stroke simulator 4 extends in a direction normal to the surface 506 of the housing 5 on which the port 514 is opened. Due to this effect, the brake system 1 can prevent or cut down an increase in a dimension of the second unit 1B including the first unit 1A in the above-described normal direction, thereby preventing or reducing imposition of a limitation on the layout when being mounted on the vehicle. More specifically, the central axis of the port 306A is approximately perpendicular to the central axis of the stroke simulator 4. Therefore, the brake system 1 allows the central axis of the stroke simulator 4 to be disposed generally in parallel with the surface 506, and therefore can maximumly prevent or cut down the increase in the dimension in the above-described normal direction. The one end side of the second connection fluid passage 305 is connected to the back-pressure chamber 402. The other end side of the fluid passage 305 (the simulator second connection port 306B) is opened at an arbitrary position on the outer surface of the housing 3. Connecting the port 306B to the unit second connection port 515 of the second unit 1B (the housing 5) establishes the connection between the back-pressure chamber 402 and the back-pressure fluid passage 17 of the second unit 1B. Further, the central axis of the port 306B has an angle (larger than 0 degrees) with respect to the central axis of the stroke simulator 4 (the back-pressure chamber 402). Therefore, an advantageous effect similar to the above-described advantageous effect can be acquired in the configuration in which the brake fluid is transmitted out from the back-pressure chamber 402 according to the movement of the piston 41 due to the brake operation performed by the driver.

The positive pressure chamber 401 (the small-diameter portion 31) of the stroke simulator 4 (the housing 3) is disposed on one side where the master cylinder ports 511 are located (the Z-axis positive direction side) in the longitudinal direction of the surface 506 (the Z-axis direction) with respect to the surface 506 of the housing 5. More specifically, the positive pressure chamber 401 is at least partially positioned on the Z-axis positive direction side with respect to the center of the surface 506 in the Z-axis direction. Therefore, the brake system 1 can reduce a distance between the master cylinder ports 511 and the positive pressure chamber 401, thereby reducing a total distance of the positive fluid passage 16 connected to the secondary port 511S and the first connection fluid passage 304 connected to the positive pressure chamber 401. As a result, the brake system 1 can simplify the fluid passage 304 in the housing 3 and improve the layout flexibility inside the housing 3. Alternatively, the brake system 1 can simplify the fluid passage 16 in the housing 5 and improve the layout flexibility inside the housing 5. Therefore, the brake system 1 can achieve the reductions in the size and the weight of the housing 3 (the first unit 1A) or the housing 5 (the second unit 1B), i.e., the reductions in the size and the weight of the second unit 1B including the first unit 1A. It is preferable that the fluid passage 304 is opened on the Z-axis positive direction side of the positive pressure chamber 401 to smoothly supply the brake fluid from the fluid passage 304 to the positive pressure chamber 401 even with the piston 41 maximumly displaced toward the Z-axis positive direction side. In the present embodiment, at least a part of the positive pressure chamber 401 on the Z-axis positive direction side is positioned on the Z-axis positive direction side of the surface 506. Therefore, the brake system 1 can further efficiently reduce the distance between the port 511 and the chamber 401.

The stroke simulator 4 (the housing 3) extends along the longitudinal direction of the surface 506 (the Z-axis direction). A range of the outer surface of the housing 3 that faces the surface 506 in the X-axis direction, and a range of the surface 506 that faces the outer surface of the housing 3 in the X-axis direction increase in the Z-axis direction. This leads to an increase in a range in the Z-axis direction where the ports 306A and 306B opened on the outer surface of the housing 3 can be disposed. In other words, layout flexibility of the ports 306 is improved. Therefore, the brake system 1 can achieve simplification of the fluid passages 304 and 305 connected to the ports 306. One end of the fluid passage 304 is connected to the positive pressure chamber 401, and one end of the fluid passage 305 is connected to the back-pressure chamber 402. The above-described one ends of these fluid passages 304 and 305 are spaced apart from each other in the Z-axis direction. Due to the wide range in the Z-axis direction where the ports 306A and 306B can be disposed, for example, the above-described one ends and other ends (the ports 306A and 306B) of the fluid passages 304 and 305 can be placed at approximately the same positions in the Z-axis direction. Due to this configuration, the brake system 1 can reduce the number of portions where the fluid passages 304 and 305 are bent, thereby achieving the simplification of the fluid passages 304 and 305. For the housing 3, the parent material thereof is prepared by casting, and the fluid passages 304 and 305 and the like are formed by machining processing. The reduction in the number of portions where the fluid passages 304 and 305 are bent leads to a reduction in the number of opening portions of the fluid passages 304 and 305 on the outer surface of the housing 3, thereby also leading to a reduction in the number of times these opening portions is sealed by press-fitting balls into these opening portions. The reduction in the number of times that the opening portions are sealed by the balls (the press-fitting) can lead to a reduction in stresses applied to the housing 3, thereby improving durability of the housing 3. Further, the present configuration leads to an increase in a range in the Z-axis direction where the ports 514 and 515 opened on the surface 506 can be disposed. In other words, layout flexibility of the ports 514 and 515 is improved. Therefore, the brake system 1 can achieve simplification of the fluid passages 16 and 17 connected to the ports 514 and 515. As a result, the brake system 1 can achieve the reductions in the size and the weight of the housing (the second unit 1B).

The fluid passage 304 is at least partially (the first portion 304A) extends on approximately the same straight line as the first bleeder fluid passage 307A. Therefore, the brake system 1 allows both the fluid passages 304A and 307A to be formed by the same processing process, and therefore can improve productivity. Similarly, the fluid passage 305 at least partially (the first portion 305A) extends on approximately the same straight line as the second bleeder fluid passage 307B, and therefore the brake system 1 can improve the productivity.

The end of the first unit 1A (the housing 3) in the Z-axis positive direction is located on the Z-axis negative direction side with respect to the end of the second unit 1B (the housing 5) in the Z-axis positive direction (the top surface 504). Therefore, the brake system 1 can prevent or reduce the protrusion of the first unit 1A beyond the second unit 1B toward the Z-axis positive direction side, thereby preventing or cutting down the increase in the dimension of the second unit 1B including the first unit 1A in the Z-axis direction. The end of the first unit 1A (the housing 3) in the Z-axis negative direction is located on the Z-axis positive direction side with respect to the end of the second unit 1B (the ECU 90) in the Z-axis negative direction. Therefore, the brake system 1 can prevent or reduce the protrusion of the first unit 1A beyond the second unit 1B toward the Z-axis negative direction side, thereby preventing or cutting down the increase in the dimension of the second unit 1B including the first unit 1A in the Z-axis direction.

The stroke simulator 4 extends along the direction of gravitational force (a direction in which the gravitational force is applied, i.e., the vertical direction) in the state mounted on the vehicle. Therefore, viewing the first unit 1A from the direction of gravitational force (the Z-axis direction) means viewing the stroke simulator 4 generally from the axial direction thereof. This leads to a reduction in an area when the first unit 1A is viewed from the direction of gravitational force (the Z-axis direction), i.e., a projection area in the direction of gravitational force. Therefore, the brake system 1 can reduce the above-described projection area of the second unit 1B including the first unit 1A, thereby improving vehicle mountability thereof. Even when the central axis of the stroke simulator 4 slightly tilts with respect to the direction of gravitational force, the above-described advantageous effect can be acquired as long as the above-described projection area of the stroke simulator 4 is smaller than a projection area of the stroke simulator 4 in a direction perpendicular to the central axis of the stroke simulator 4. In the present embodiment, the central axis of the stroke simulator 4 extends in the Z-axis direction. Therefore, the brake system 1 can maximumly reduce the above-described projection area in the state mounted on the vehicle, thereby preventing or cutting down an increase in the dimension of the first unit 1A in the horizontal direction (the X-axis direction or the Y-axis direction).

The central axes of the bleeder portions 371 and 372 (the bleeder fluid passages 307A and 307B) extend generally in parallel with the surface 506. Therefore, the brake system 1 prevents or reduces extension of the bleeder portions 371 and 372 and protrusion of the bleeder valves BV in the direction normal to the surface 506 (the X-axis direction). Due to this effect, the brake system 1 can prevent or cut down the increase in the dimension of the second unit 1B including the first unit 1A in the above-described normal direction, thereby preventing or reducing the imposition of the limitation on the layout when being mounted on the vehicle. The central axes of the bleeder portions 371 and 372 (the bleeder fluid passages 307A and 307B) extend generally in parallel with the axial direction of the motor housing 200 (the Y-axis direction) toward the front surface 501 side. Therefore, the bleeder portions 371 and 372 and the bleeder valves BV are disposed in the space between the first unit 1A (the stroke simulator 4) and the motor housing 200 (the cylindrical portion 201). Due to this configuration, the brake system 1 can achieve compactification of the second unit 1B including the first unit 1A and facilitate the air removal work performed by opening and closing the bleeder valves BV.

The cylinder containing holes 53A to 53E are arrayed in one row along the axial direction of the motor 20. The plurality of pump portions 2A to 2E overlaps one another in the Y-axis direction. Therefore, the brake system 1 allows the cam unit 2U to be used in common among the plurality of pump portions 2A to 2E, and therefore can prevent or cut down increases in the number of components and cost. Further, the brake system 1 can reduce the rotational driving shaft of the pump 2, thereby preventing or cutting down the increase in the dimension of the housing 5 in the Y-axial direction. Further, the brake system 1 can simplify the layout of the fluid passages due to the overlap among the plurality of pump portions 2A to 2E in the axial direction of the rotational driving shaft, thereby preventing or cutting down the increase in the size of the housing 5. The cylinder containing holes 53 are disposed on the front surface 501 side of the housing 5 (one side where the motor 20 is mounted). Therefore, the brake system 1 can further shorten the rotational driving shaft, thereby improving the layout flexibility inside the housing 5. The plurality of valve containing holes is arrayed in one row along the axial direction of the motor 20. Therefore, the brake system 1 can prevent or cut down the increase in the dimension of the housing 5 in the Y-axis direction. The valve containing holes are disposed on the back surface 502 side of the housing 5 (the other side where the ECU 90 is attached). Therefore, the brake system 1 can improve electric connectivity between the ECU 90 and the solenoids of the electromagnetic valves 21 and the like. More specifically, the central axes of the plurality of valve containing holes extend generally in parallel with the central axis of the motor 20, and all the valve containing holes are opened on the back surface 502. Therefore, the brake system 1 allows the solenoids of the electromagnetic valves 21 and the like to be collectively disposed on the back surface 502 of the housing 5, and therefore can simplify the electric connections between the ECU 90 and the solenoids. Similarly, the plurality of sensor containing holes is disposed on the back surface 502 side. Therefore, the brake system 1 can improve electric connectivity between the ECU 90 and the hydraulic sensors 91 and the like. The control board of the ECU 90 is disposed generally in parallel with the back surface 502. Therefore, the brake system 1 can simplify the electric connections between the ECU 90 and the solenoids (and the sensors).

The plurality of cylinder containing holes 53 and valve containing holes at least partially overlap each other as viewed from the Y-axis direction. Therefore, the brake system 1 can reduce the area of the second unit 1B as viewed from the motor 20 side. The housing 5 includes a pump region (a pump portion) and an electromagnetic valve region (an electromagnetic valve portion) in this order from the front surface 501 side to the back surface 502 side along the axial direction of the motor 20. The region where the cylinder containing holes 53 are positioned is the pump region and the region where the valve containing holes are positioned is the electromagnetic valve region along the axial direction of the motor 20. The brake system 1 can easily prevent or cut down the increase in the dimension of the housing 5 in the axial direction of the motor 20 by allowing the cylinder containing holes 53 and the valve containing holes to be collectively disposed for each of the regions in the axial direction of the motor 20 in this manner. Further, the brake system 1 can improve the layout flexibility of each of the elements in the housing 5 and achieve the reduction in the size of the housing 5. In other words, the brake system 1 increases the degree of freedom of the layout of the plurality of holes in the plane perpendicular to the central axis of the motor 20 in each of the regions. For example, the brake system 1 facilitates disposing the plurality of valve containing holes in the electromagnetic valve region so as to prevent or cut down the increase in the dimension of the housing 5 in the above-described plane. These regions may partially overlap each other in the axial direction of the motor 20.

The wheel cylinder ports 512 are opened on the top surface 504. Therefore, the brake system 1 can save the space of the front surface 501 and facilitate the formation of the recessed portions 50A and 50B at the corner portions of the housing 5 compared to when the ports 512 are opened on the front surface 501. The ports 512 are disposed on the Y-axis negative direction side of the top surface 504. Therefore, by disposing the ports 512 in the electromagnetic valve region, the brake system 1 can facilitate the connections between the ports 512 and the SOL/V IN containing holes and the like while avoiding the interference between the ports 512 and the cylinder containing holes 53, thereby simplifying the fluid passages. The four ports 512 are disposed so as to be arranged in the X-axis direction on the Y-axis negative direction side of the top surface 504. Therefore, the brake system 1 can prevent or cut down the increase in the dimension of the housing 5 in the Y-axis direction by arranging the ports 512 in one row in the Y-axis direction.

The master cylinder ports 511 are opened on the front surface 501. Therefore, the brake system 1 can save the space of the top surface 504 and facilitate the formation of the wheel cylinder ports 512 and the like on the top surface 504 compared to when the ports 511 are opened on the top surface 504. The ports 511 overlap the motor housing 200 in the X-axis direction (as viewed from the Z-axis direction). Therefore, the brake system 1 can prevent or cut down an increase in a dimension of the front surface 501 in the X-axis direction. The ports 511P and 511S sandwich the first fluid pool chamber 521 there between in the X-axis direction (as viewed from the Y-axis direction). In other words, the first fluid pool chamber 521 is disposed between the ports 511P and 511S in the X-axis direction. By utilizing the space between the ports 511P and 511S to form the first fluid pool chamber 521 in this manner, the brake system 1 can improve the layout flexibility inside the housing 5 and can also reduce the area of the front surface 501, thereby achieving the reduction in the size of the housing 5. Each of the ports 511P and 511S is sandwiched between the chamber 521 and the cylinder containing hole 53D or 53C in the direction around the central axis O (as viewed from the Y-axis direction). Therefore, the brake system 1 can prevent or cut down an increase in a dimension from the central axis O to the outer surface (the top surface 504) of the housing 5, thereby achieving the reduction in the size of the housing 5. Further, the brake system 1 allows the opening portions of the ports 511 on the front surface 501 to be disposed on the central side in the X-axis direction, thereby facilitating the formation of the recessed portions 50A and 50B outside the ports 511P and 511S in the X-axis direction. The front surface 501 side and the top surface 504 side of the housing 5 are reduced in volume and thus reduced in weight by amounts corresponding to the recessed portions 50A and 50B. The intake port 513 is located on the Y-axis positive direction side (the pump region). Therefore, the brake system 1 facilitates the connection of the port 513 (the first fluid pool chamber 521) to the cylinder containing holes 53 (the intake portions of the pump portions 2C and 2D), and therefore can simplify the fluid passages. The port 513 is located on the central side in the X-axis direction. Therefore, in the case where the single first fluid pool chamber 521 is used for both the P and S systems in common, the brake system 1 facilitates the connection of the port 513 (the chamber 521) to the valve containing holes of both the systems, and therefore can simplify the fluid passages. The wheel cylinder ports 512c and 512d sandwich the intake port 513 (the chamber 521) therebetween, and the openings of the ports 512c and 512d and the port 513 (the chamber 521) also partially overlap each other in the X-axis direction (as viewed from the Y-axis direction). Therefore, the brake system 1 can prevent or cut down the increase in the dimension of the housing 5 in the X-axis direction, thereby achieving the reduction in the size. With the central axis of the first fluid pool chamber 521 extending in the direction perpendicular to the central axis O and the chamber 521 opened on the outer surface (the top surface 504) of the housing 5 intersecting with this direction (extending along the direction around the central axis O), this opening portion functions as the intake port 513. Therefore, the brake system 1 can prevent or cut down the increase in the dimension from the central axis O to the outer surface (the top surface 504 on which the chamber 521 is opened) of the housing 5 extending along the direction around the central axis O, thereby achieving the reduction in the size of the housing 5.

The first fluid pool chamber 521, the power source hole 55, and the second fluid pool chamber 522 are formed in a region between the adjacent cylinder containing holes 53 in the direction around the central axis O. Therefore, the brake system 1 can shorten the intake fluid passage 12 connecting the chamber 521 and the intake portions of the pump portions 2C and 2D to each other. Further, by utilizing the space between the adjacent holes 53 to form the chambers 521 and 522 and the hole 55, the brake system 1 can improve the layout flexibility (volume efficiency) inside the housing 5 and can also reduce the area of the front surface 501, thereby achieving the reduction in the size of the housing 5. The chamber 521 is disposed in the region surrounded by the master cylinder ports 511P and 511S and the wheel cylinder ports 512c and 512d. More specifically, the chamber 521 overlaps each of the above-described port 511P and the like in the Z-axis direction, and is also located inside a quadrilateral defined by connecting the above-described port 511P and the like with line segments as viewed from the Z-axis direction. By utilizing the space between the above-described port 511P and the like to form the chamber 521 in this manner, the brake system 1 can improve the layout flexibility inside the housing 5 and also achieve the reduction in the size of the housing 5. The central axis of the second fluid pool chamber 522 extends in the direction perpendicular to the central axis O, and the chamber 522 is opened on the outer surface (the bottom surface 503) of the housing 5 intersecting with this direction (extending along the direction around the central axis O). Therefore, the brake system 1 can prevent or cut down an increase in a dimension from the central axis O to the outer surface (the bottom surface 503 on which the chamber 522 is opened) of the housing 5 extending along the direction around the central axis O, thereby achieving the reduction in the size of the housing 5. The holes 53A to 53E and the chamber 522 partially overlap each other in the Y-axis direction (as viewed from the X-axis direction). Therefore, the brake system 1 can prevent or cut down the increase in the dimension of the housing 5 in the Y-axis direction, thereby achieving the reduction in the size. The chamber 522 is opened on the Y-axis positive direction side on the bottom surface 503. Therefore, the brake system 1 facilitates the connection of the chamber 522 to the regions in the cam containing holes where the holes 53A to 53E are opened, and therefore can simplify the drain fluid passage.

The pin holes 569 for the fixation to the mount are provided on the bottom surface 503 of the housing 5. The holes 569 are opened on the bottom surface 503, and extend in the vertical direction (the Z-axis direction). The pins fixed in the holes 569, and the insulators attached to the pins also extend in the vertical direction. Therefore, the brake system 1 causes the insulators to receive the weight of the second unit 1B (a load due to the gravitational force applied downward in the vertical direction) in the axial direction thereof and efficiently support this load in the vertical direction, and therefore can stably support the second unit 1B with respect to the vehicle body side (the mount). The bolt holes 567 and 568 for the fixation to the mount are provided on the lower side in the vertical direction on the front surface 501 of the housing 5 with respect to the central axis O. The holes 567 and 568 are opened on the front surface 501, and extend in the horizontal direction. The second unit 1B can be stably held by supporting the bottom surface 503 and the front surface 501 of the housing 5. The brake system 1 causes the support portion of the bottom surface 503 and the support portion of the front surface 501 to support the housing 5 in directions different from each other, and therefore can improve support strength against loads possibly applied to the housing 5 in multiple directions. The pin holes 569 are disposed on the Y-axis negative direction side of the bottom surface 503. Therefore, the brake system 1 increases a distance between the support portion of the front surface 501 (the bolt holes 567 and 568) and the support portion of the bottom surface 503 (the pin holes 569), and therefore can further stably support the second unit 1B. The brake system 1 causes a center of gravity of the second unit 1B to be positioned on the lower side in the vertical direction, and therefore can improve installation stability of the second unit 1B. The first recessed portion 50A and the second recessed portion 50B are opened on the top surface 504. The top surface 504 side of the housing 5 is reduced in weight by the amount corresponding to the recessed portions 50A and 50B. Therefore, the brake system 1 allows the center of gravity of the second unit 1B to be easily positioned on the lower side in the vertical direction. Further, the brake system 1 causes a center of gravity of the first unit 1A to be positioned on the lower side in the vertical direction, and therefore can improve installation stability of the second unit 1B including the first unit 1A. The positive pressure chamber 401 (the small-diameter portion 31) is disposed on the Z-axis positive direction side with respect to the back-pressure chamber 402 (the large-diameter portion 33). The small-diameter portion 31 side can be more easily reduced in weight than the large-diameter portion 33 side. Therefore, the brake system 1 allows the center of gravity of the first unit 1A to be easily positioned on the lower side in the vertical direction.

(Improvement of Workability)

The master cylinder ports 511 and the wheel cylinder ports 512 are disposed on the upper side of the housing 5 in the vertical direction. Therefore, the brake system 1 can improve workability when the pipes 10MP, 10MS, and 10W are respectively attached to the ports 511 and 512 of the housing 5 that are set on the vehicle body side. The wheel cylinder ports 512 are opened on the top surface 504. Therefore, the brake system 1 can further improve the above-described workability. The master cylinder ports 511 are opened on the end portions of the front surface 501 on the upper side in the vertical direction. Therefore, the brake system 1 can further improve the above-described workability. Further, the brake system 1 causes the intake port 513 in communication with the first fluid pool chamber 521 to be disposed on the top surface 504, thereby facilitating handling of the pipe connected to the intake port 513. Further, the brake system 1 facilitates work engaged from above at the time of the mounting onto the vehicle.

When the pipes 10M are fixed to the ports 511 on the front surface 501, nuts are fastened with use of a tool. The tool approaches the front surface 501. If parts of the bolts b2 for attaching the ECU 90 to the back surface 502 protrude into the front surface 501, this makes it difficult to fasten the nuts with use of the tool. In the present embodiment, the parts (the head portions) of the bolts b2 protrude into the first recessed portion 50A and the second recessed portion 50B, respectively. In other words, the parts of the bolt b2 on the Z-axis positive direction side do not protrude into the front surface 501 except for the recessed portions 50A and 50B. Therefore, the brake system 1 prevents or reduces interference between the parts of the bolts b2 and the tool, thereby facilitating the work of fixing the pipes 10M to the port 511 with use of the tool. The cylinder containing holes 53C and 53D are opened to the recessed portions 50A and 50B, respectively. Therefore, the brake system 1 can prevent or cut down increases in axial dimensions of the holes 53C and 53D, thereby improving efficiency of attaching the pump components into the holes 53C and 53D.

A space for the air removal work should be prepared around the bleeder valves BV. At least one of the valves BV is disposed on the upper side of the housing 3 in the vertical direction (the Z-axis positive direction side). The presence of the valve BV on the upper side in the vertical direction can facilitate the air removal work performed by opening and closing the valve BV. The valves BV (the ports 308) are oriented toward the Y-axis direction side. Therefore, the brake system 1 can reduce the space adjacent to the second unit 1B including the first unit 1A in the X-axis direction. The valves BV (the ports 308) are oriented toward the front surface 501 side (the Y-axis positive direction side). The end of the housing 3 in the Y-axis positive direction is located on the Y-axis negative direction side with respect to the end of the motor housing 200 in the Y-axis positive direction (refer to FIG. 7). Therefore, the brake system 1 can achieve the size reduction and compactification of the second unit 1B including the first unit 1A by utilizing the space between these housings 3 and 200 to place the valves BV here.

(Prevention of Detachment of Plug Member)

The plug member 48 of the stroke simulator 4 is provided on the Z-axis negative direction side of the stroke simulator 4. Due to this configuration, the plug member 48 is exposed to the lower side in the vertical direction with the brake system 1 mounted on the vehicle. After the brake system 1 is mounted on the vehicle, the plug member 48 cannot be visually confirmed from above. Due to this configuration, the brake system 1 can prevent or reduce unintended detachment of the plug member 48.

Next, advantageous effects will be described.

(1) The hydraulics control apparatus includes the second unit 1B (a hydraulic unit) and the first unit 1A (a stroke simulator unit). The second unit 1B includes the housing 5 including the brake fluid passage therein, the positive pressure fluid passage 16 and the back-pressure fluid passage (a unit connection fluid passage) each having the one end side connected to the brake fluid passage, the positive pressure port 514 and the back-pressure port 515 (a unit connection port) provided on the surface of the housing 5 and connected to the other end sides of the positive pressure fluid passage 16 and the back-pressure fluid passage 17, the pump 2 (a hydraulic source) provided inside the housing 5 and configured to generate the hydraulic pressure in each of the wheel cylinders W/C of the vehicle via the brake fluid passage, and the motor 20 attached to the surface of the housing 5 and configured to actuate the pump 2. The first unit 1A includes the stroke simulator 4. The stroke simulator 4 is provided as a different unit from the master cylinder 7 configured to generate the hydraulic pressure according to the brake pedal operation. The stroke simulator 4 is disposed in such a manner that the actuation axis direction thereof coincides with the longitudinal direction of the right side surface 506 (a side surface) with respect to the front surface 501 (a motor attachment surface) of the housing 5. The stroke simulator 4 is configured to generate the reaction force of the brake pedal operation. The first unit 1A further includes the first connection fluid passage 304 and the second connection fluid passage 305 (a simulator connection fluid passage) each having the one end side connected to the stroke simulator 4, and the simulator first connection port 306A and the simulator second connection port 306B (a simulator connection port). The simulator first connection port 306A and the simulator second connection port 306B are provided on the other end sides of the first simulator connection fluid passage 304 and the second connection fluid passage 305. The simulator first connection port 306A and the simulator second connection port 306B are connected to the positive pressure port 514 and the back-pressure port 515. The simulator first connection port 306A and the simulator second connection port 306B overlap the positive pressure port 514 and the back-pressure port 515 as viewed from the axial directions of the positive pressure port 514 and the back-pressure port 515.

Therefore, the first embodiment can improve the vehicle mountability.

(2) The positive pressure port 514 and the back-pressure port 515 are provided on the right side surface 506.

Therefore, the first embodiment can achieve the reduction in the size of the housing 5.

(3) The stroke simulator 4 is disposed on the opposite side of the front surface 501 from the back surface 502 in the rotational axis direction of the motor 20.

Therefore, the first embodiment can prevent or cut down the increase in the size of the second unit 1B including the first unit 1A and the motor 20.

(4) The stroke simulator 4 is disposed so as to overlap the front surface 501 when being viewed from the rotational axis direction of the motor 20.

Therefore, the first embodiment can further prevent or cut down the increase in the size of the second unit 1B including the first unit 1A and the motor 20.

(5) The stroke simulator 4 is disposed between the front surface 501 and the bottom portion 202 (an end surface) of the motor 20 opposite from the front surface 501 in the rotational axis direction of the motor 20.

Therefore, the first embodiment can prevent or cut down the increase in the size of the second unit 1B including the first unit 1A and the motor 20.

(6) The first unit 1A is disposed on the front surface 501 side with respect to the bottom portion 202 of the motor 20 in the rotational axis direction of the motor 20.

Therefore, the first embodiment can prevent or cut down the increase in the size of the second unit 1B including the first unit 1A and the motor 20.

(7) The surfaces of the housing 5 include the front surface 501 (a first surface) on which the motor is attached, the back surface 502 (a second surface) located opposite of the housing 5 from the front surface 501 on which the ECU 90 (a control unit) for driving the motor 20 is disposed, the top surface 504 (a third surface) provided continuously to the front surface 501 and the back surface 502 on which the wheel cylinder ports 512 (a wheel cylinder connection port) are disposed with the wheel cylinder ports 512 connected to the wheel cylinder pipes 10W leading to the wheel cylinders W/C, and the right side surface 506 (a fourth surface) provided continuously to the front surface 501, the back surface 502, and the top surface 504, on which the positive pressure port 514 and the back-pressure port 515 port are disposed.

Therefore, the first embodiment can improve the vehicle mountability.

(8) The stroke simulator 4 is disposed on the opposite side of the front surface 501 from the back surface 502 (the second surface) in the rotational axis direction of the motor 20.

Therefore, the first embodiment can prevent or cut down the increase in the size of the second unit 1B including the first unit 1A and the motor 20.

(9) The stroke simulator 4 is disposed so as to overlap the front surface 501 when being viewed from the rotational axis direction of the motor 20.

Therefore, the first embodiment can further prevent or cut down the increase in the size of the second unit 1B including the first unit 1A and the motor 20.

(10) The stroke simulator 4 is disposed between the front surface 501 and the bottom portion 202 of the motor 20 in the rotational axis direction of the motor 20.

Therefore, the first embodiment can prevent or cut down the increase in the size of the second unit 1B including the first unit 1A and the motor 20.

(11) The first unit 1A is disposed on the front surface 501 side with respect to the bottom portion 202 of the motor 20 in the rotational axis direction of the motor 20.

Therefore, the first embodiment can prevent or cut down the increase in the size of the second unit 1B including the first unit 1A and the motor 20.

(12) The surfaces of the housing 5 include the left side surface 505 (a fifth surface) located opposite of the housing 5 from the right side surface 506 and facing the connector portion 903 for electrically connecting the ECU 90 to the external device.

Therefore, the first embodiment can facilitate the connection of the connector (the harness) to the connector portion 903.

(13) The surfaces of the housing 5 include the bottom surface 503 (a sixth surface) located opposite of the housing 5 from the top surface 504 on which the pin holes 569 for fixing the housing 5 to the vehicle body side of the vehicle are opened.

Therefore, the first embodiment allows the second unit 1B to be stably supported on the vehicle body side (the mount).

(14) The stroke simulator 4 includes the piston 41 defining the positive pressure chamber 401 (a first chamber) and the back-pressure chamber 402 (a second chamber) in the cylinder 30. The plug member 48 forming the back-pressure chamber 402 together with the cylinder 30 and the piston 41 is provided in the actuation axis direction of the stroke simulator 40 and on the bottom surface 503 side.

Therefore, the first embodiment can prevent or reduce the unintended detachment of the plug member 48.

(15) The stroke simulator 4 includes the piston 41 defining the positive pressure chamber 401 and the back-pressure chamber 402 in the cylinder 30, the first bleeder valve BV1 provided in the positive pressure chamber 401, and the second bleeder valve BV2 provided in the back-pressure chamber 402. The first bleeder valve BV1 and the second bleeder valve BV2 are disposed in the rotational axis direction of the motor 20 toward the front surface 501 side with respect to the cylinder 30.

Therefore, the first embodiment can achieve compactification of the second unit 1B including the first unit 1A and facilitate the air removal work performed by opening and closing the bleeder valves BV.

(16) The hydraulics control apparatus includes the housing 5 including the brake fluid passage therein, the pump 2 (a hydraulic source) provided inside the housing 5 and configured to generate the hydraulic pressure in each of the wheel cylinders W/C of the vehicle via the brake fluid passage, the motor 20 attached to the surface of the housing 5 and configured to actuate the pump 2, and the stroke simulator 4. The stroke simulator 4 is provided as a different unit from the master cylinder 7 configured to generate the hydraulic pressure according to the brake pedal operation. The stroke simulator 4 is disposed in such a manner that the actuation axis direction thereof coincides with the longitudinal direction of the right side surface 506 (a side surface) with respect to the front surface 501 (a motor attachment surface) of the housing 5. The stroke simulator 4 is configured to generate the reaction force of the brake pedal operation.

Therefore, the first embodiment can improve the vehicle mountability.

(17) The stroke simulator 4 is disposed on the opposite side of the front surface 501 from the back surface 502 in the rotational axis direction of the motor 20.

Therefore, the first embodiment can prevent or cut down the increase in the size of the second unit 1B including the first unit 1A and the motor 20.

(18) The stroke simulator 4 is disposed so as to overlap the front surface 501 when being viewed from the rotational axis direction of the motor 20.

Therefore, the first embodiment can further prevent or cut down the increase in the size of the second unit 1B including the first unit 1A and the motor 20.

(19) The stroke simulator 4 is disposed between the front surface 501 and the bottom portion 202 (an end surface) of the motor 20 in the rotational axis direction of the motor 20.

Therefore, the first embodiment can prevent or cut down the increase in the size of the second unit 1B including the first unit 1A and the motor 20.

(20) The brake system includes the hydraulic unit, the stroke simulator unit, and the third unit 1C (a master cylinder unit). The hydraulic unit includes the housing 5 including the brake fluid passage therein, the positive pressure fluid passage 16 and the back-pressure fluid passage (a unit connection fluid passage) each having the one end side connected to the brake fluid passage, the positive pressure port 514 and the back-pressure port 515 (a unit connection port) provided on the surface of the housing 5 and connected to the other end sides of the positive pressure fluid passage 16 and the back-pressure fluid passage 17, the pump 2 (a hydraulic source) provided inside the housing 5 and configured to generate the hydraulic pressure in each of the wheel cylinders W/C of the vehicle via the brake fluid passage, and the motor 20 attached to the surface of the housing and configured to actuate the hydraulic source. The stroke simulator unit includes the stroke simulator. The stroke simulator is provided as a different unit from the master cylinder configured to generate the hydraulic pressure according to the brake pedal operation. The stroke simulator is disposed in such a manner that the actuation axis direction thereof coincides with the longitudinal direction of the side surface with respect to the motor attachment surface of the housing. The stroke simulator is configured to generate the reaction force of the brake pedal operation. The stroke simulator unit further includes the simulator connection fluid passage having the one end side connected to the stroke simulator, and the simulator connection port. The simulator connection port is provided on the other end side of the simulator connection fluid passage. The simulator connection port is connected to the unit connection port. The simulator connection port overlaps the unit connection port as viewed from the axial direction of the unit connection port. The third unit 1C (the master cylinder unit) is attached to the third unit 1C, and includes the master cylinder 7 configured to generate the hydraulic pressure according to the brake pedal operation.

Therefore, the first embodiment can improve the vehicle mountability.

### Second Embodiment

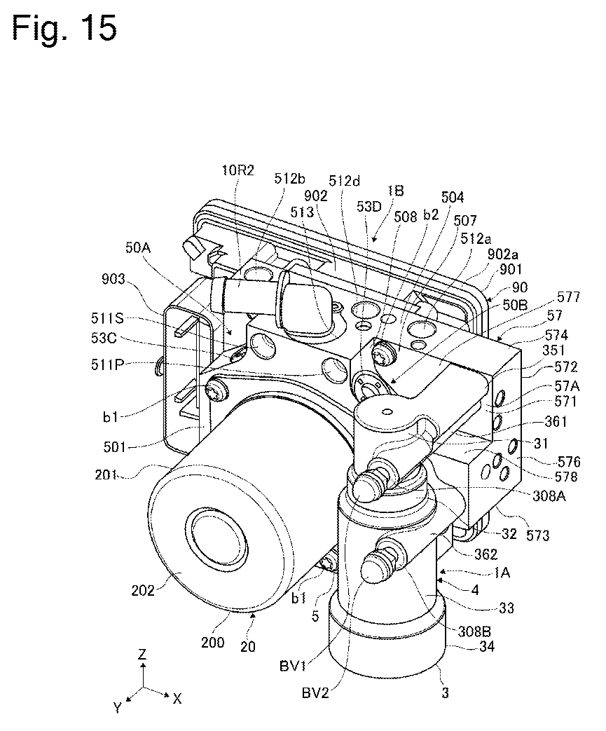

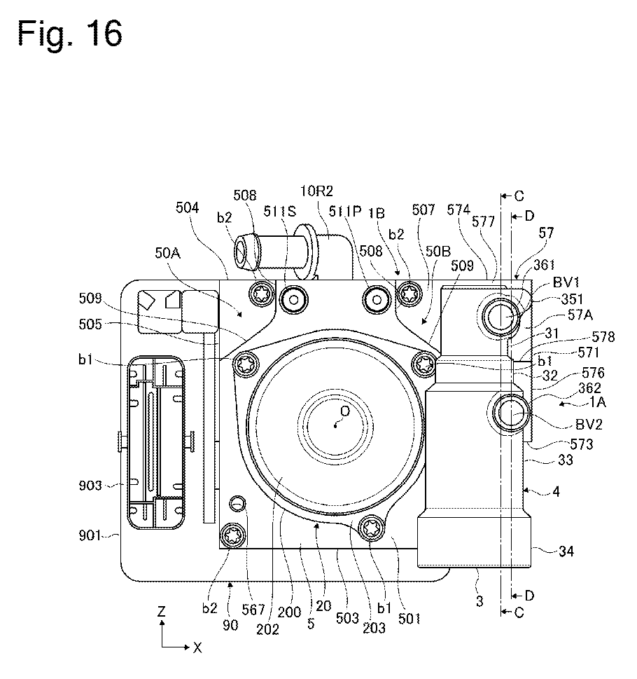

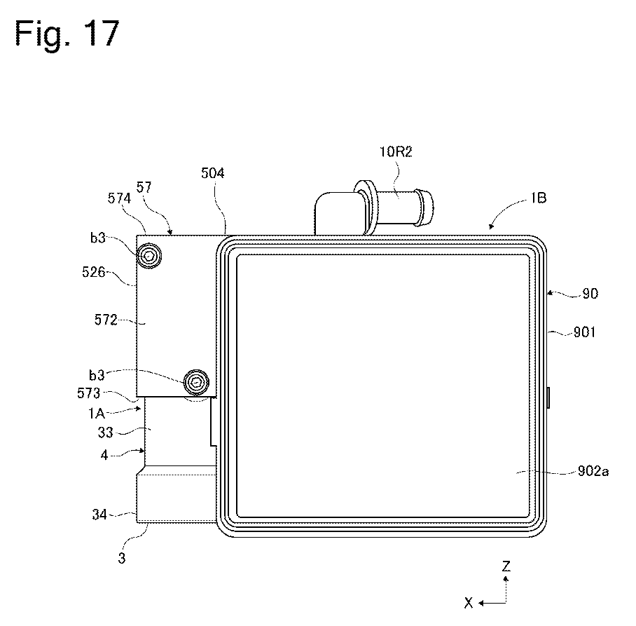

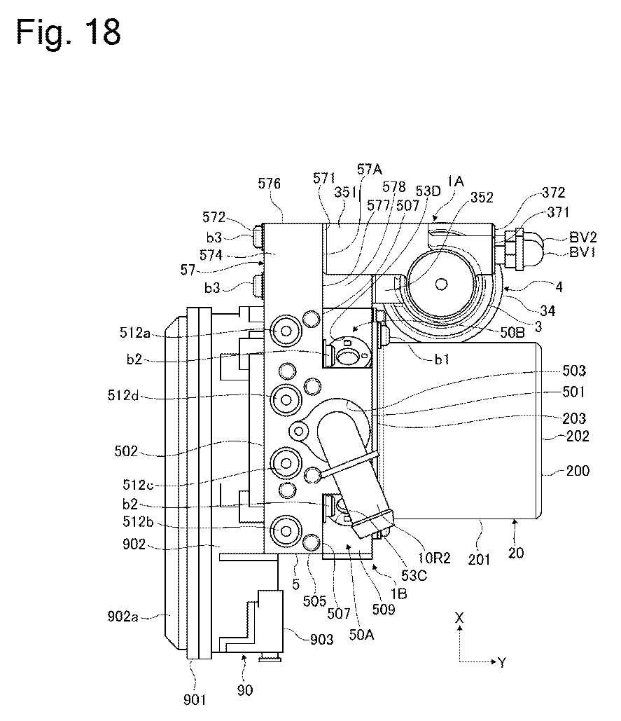

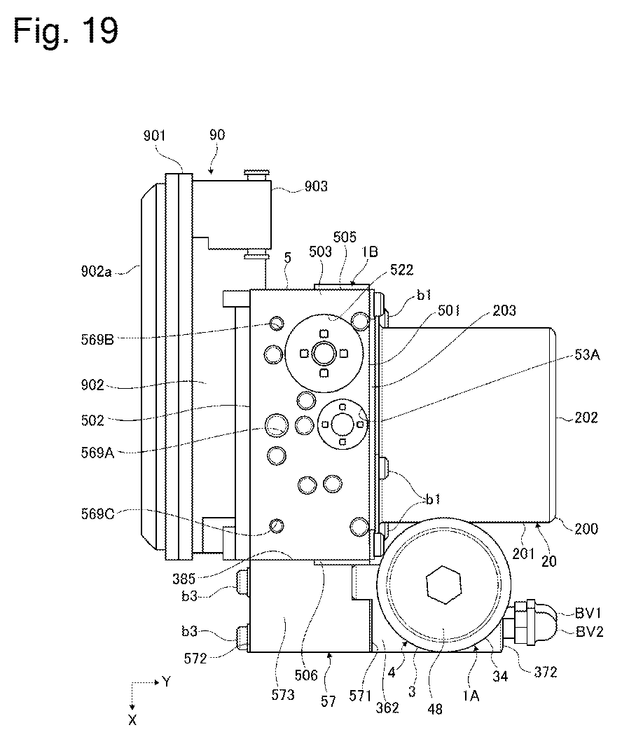

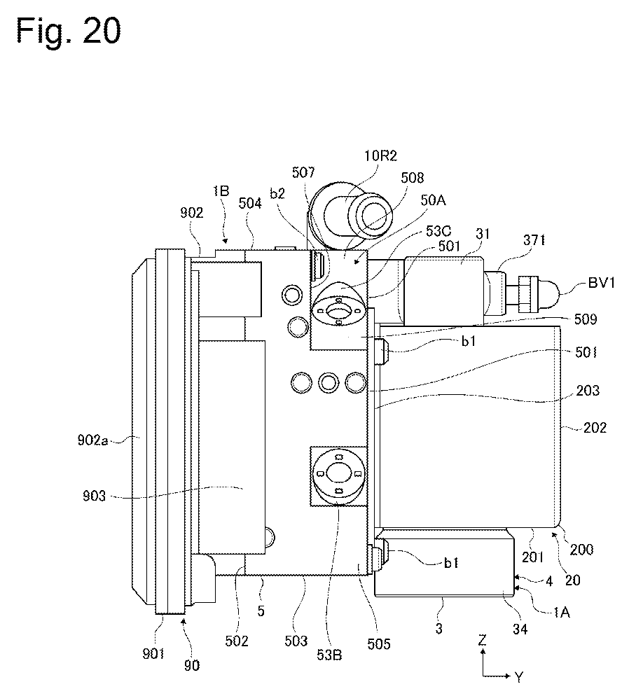

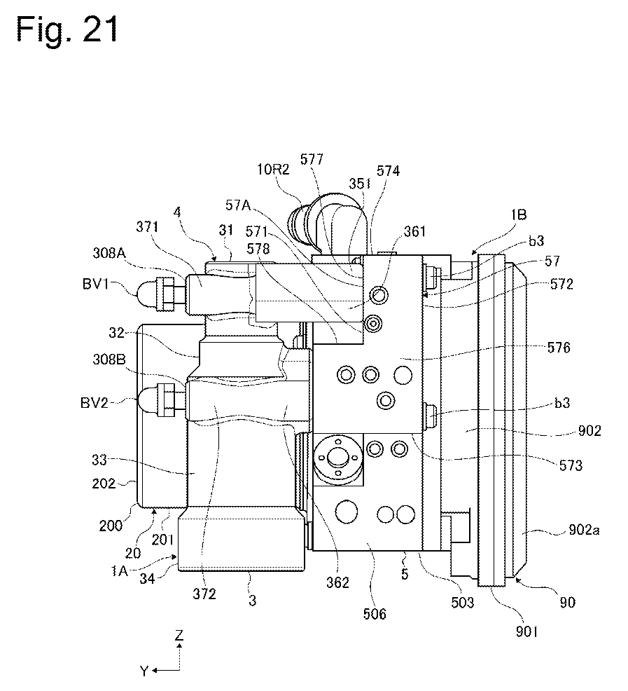

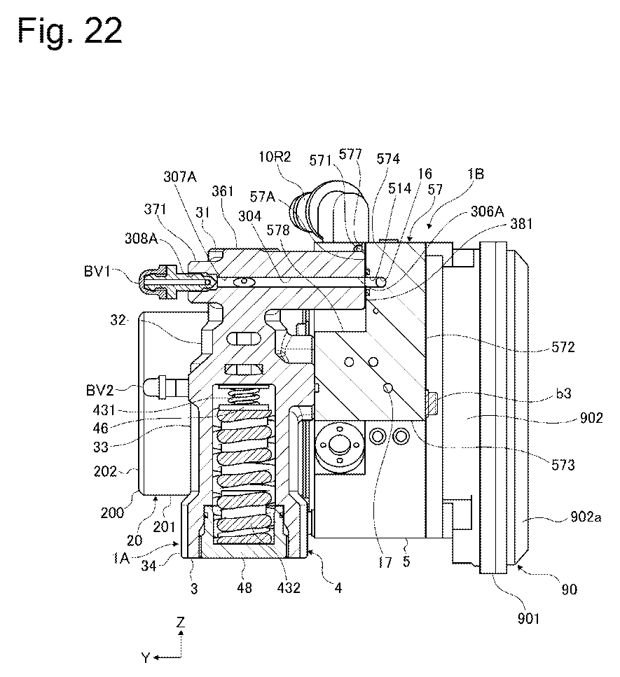

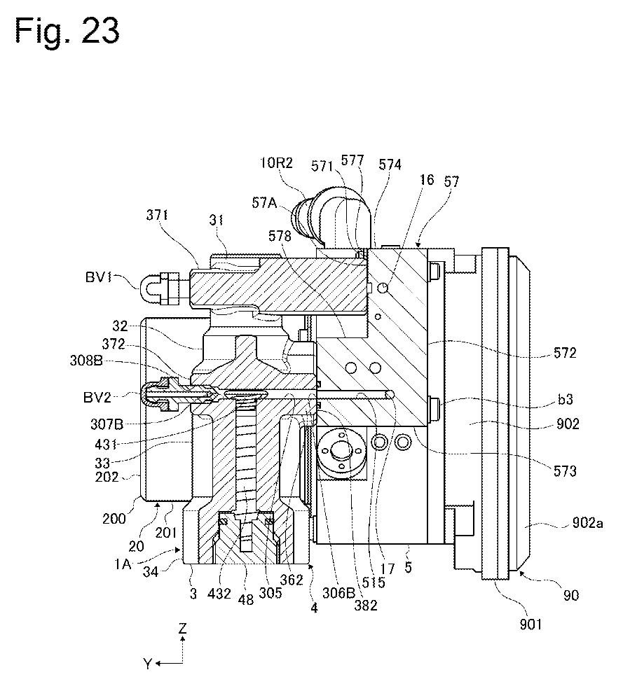

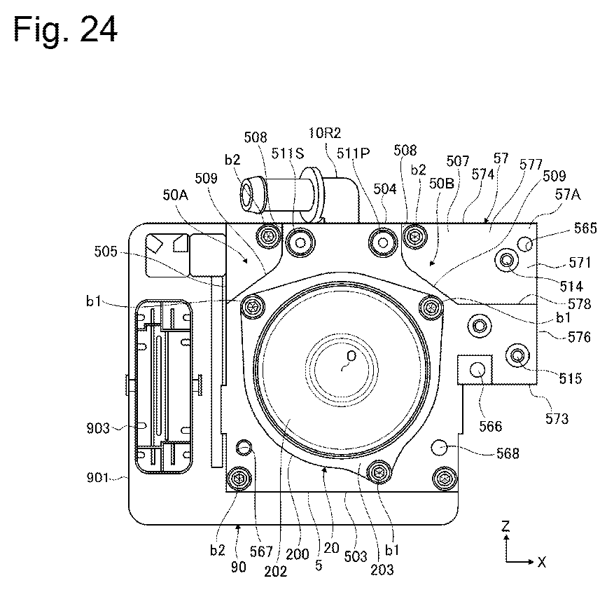

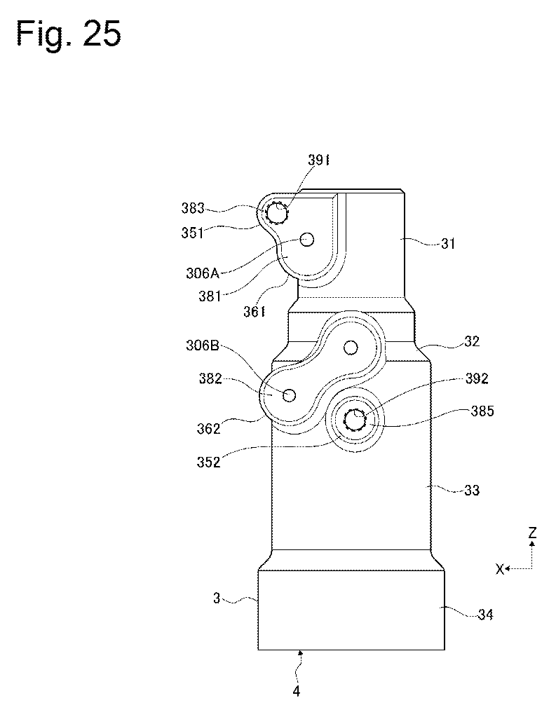

First, a configuration will be described. In the following description, a second embodiment will be described, identifying a configuration shared with the first embodiment by the same reference numeral as the first embodiment and omitting a description thereof. FIGS. 15 to 21 illustrate an outer appearance of the second unit 1B with the first unit 1A attached thereto as viewed from each direction. FIG. 15 is a perspective view of the first unit 1A and the second unit 1B as viewed from an angle (the X-axis positive direction side, the Y-axis positive direction side, and the Z-axis positive direction side). FIG. 16 is a front view as viewed from the Y-axis positive direction side. FIG. 17 is a back view as viewed from the Y-axis negative direction side. FIG. 18 is a top view as viewed from the Z-axis positive direction side. FIG. 19 is a bottom view as viewed from the Z-axis negative direction side. FIG. 20 is a left side view as viewed from the X-axis negative direction side. FIG. 21 is a right side view as viewed from the X-axis positive direction side. FIG. 22 is a cross-sectional view taken along a line C-C in FIG. 16. FIG. 23 is a cross-sectional view taken along a line D-D in FIG. 16. FIG. 24 is a right side view of the outer appearance of the second unit 1B as viewed from the Y-axis positive direction side. FIG. 25 is a left side view of the outer appearance of the first unit 1A as viewed from the Y-axis negative direction side.

First, a configuration of the first unit 1A will be described. The housing 3 includes the first flange portion 351, the second flange portion 352, the first fluid passage portion 361, the second fluid passage portion 362, the first bleeder portion 371, and the second bleeder portion 372. These first flange portion 351 and the like protrude outward from the outer surface of the housing 3. The first fluid passage portion 361 is disposed at an intermediate portion of the small-diameter portion 31 in the Z-axis direction. The second fluid passage portion 362 is disposed at an end of the large-diameter portion 33 in the Z-axis positive direction. The first flange portion 351 is disposed at an end of the small-diameter portion 31 in the Z-axis positive direction. The second flange portion 352 is disposed at an end of the large-diameter portion 33 in the Z-axis positive direction. The first fluid passage portion 361 extends in the Y-axis negative direction from the end of the small-diameter portion 31 in the X-axis positive direction. As viewed from the X-axis positive direction side, the first fluid passage portion 361 has a linear end in the Z-axis negative direction, and an end in the Z-axis positive direction that is integrated with the first flange portion 351. As viewed from the Y-axis direction, the first fluid passage portion 361 has a semi-circular Z-axis negative direction side. The first fluid passage portion 361 has the surface 381 generally in parallel with the XZ plane on the end thereof in the Y-axis negative direction. The second fluid passage portion 362 extends in the Y-axis negative direction from the end of the large-diameter portion 33 in the X-axis positive direction. As viewed from the X-axis direction, the second fluid passage portion 362 has linear ends as both the ends in the Z-axis direction. The second fluid passage portion 362 has the surface 382 generally in parallel with the XZ plane on the end thereof in the Y-axis negative direction. As viewed from the Z-axis direction, the surface 382 is positioned on the Y-axis negative direction side with respect to the side surface of the large-diameter portion 33 on the Y-axis negative direction side and on the Y-axis positive direction side with respect to the surface 381. The first bleeder portion 371 and the second bleeder portion 372 are configured similarly to the first embodiment.

The first fluid passage portion 351 extends in the Y-axis negative direction from the end of the small-diameter portion 31 in the X-axis positive direction. As viewed from the X-axis direction, the first flange portion 351 has a linear end in the Z-axis positive direction, and a linear end in the Y-axis negative direction. As viewed from the Y-axis direction, the flange portion 351 has a semi-circular end in the X-axis positive direction, and a linear end in the X-axis negative direction. The first flange portion 351 includes the surface 383 generally in parallel with the XZ plane on the end thereof in the Y-axis negative direction. The first flange portion 351 includes the bolt hole 391 having a bottomed cylindrical shape extending in the Y-axis direction at the approximately central position thereof in the Z-axis direction. The bolt hole 391 is opened on the surface 383. The surface 383 is positioned in the same plane as the surface 381. The second flange portion 352 extends in the Y-axis negative direction from the central portion of the large-diameter portion 33 in the X-axis direction. As viewed from the Y-axis direction, the second flange portion 352 is circular. The second flange portion 352 has the surface 385 generally in parallel with the XZ plane on the end thereof in the Y-axis negative direction. The surface 385 is positioned in the same plane as the surface 382. The second flange portion 352 includes the bolt hole 392 having a bottomed cylindrical shape extending along a central axis thereof set on a center of the above-described circular surface 385 and extending in the Y-axis direction. The bolt hole 392 is opened on the surface 385.

The cylinder 30, the plurality of fluid passages, and the plurality of ports are formed inside the housing 3. The cylinder 30 has a bottomed cylindrical shape extending in the Z-axis direction, and is closed and opened on the Z-axis positive direction side (the small-diameter portion 31 side) and the Z-axis negative direction side (the end portion 34 side) thereof, respectively. The cylinder 30 includes the small-diameter portion 301 and the large-diameter portion 302 on the Z-axis positive direction side (the inner peripheral side of the small-diameter portion 31) and the Z-axis negative direction side (the inner peripheral side of the large-diameter portion 33) thereof, respectively. The first seal groove 303A and the second seal groove 303B are provided on the small-diameter portion 301 at the approximately central position in the Z-axis direction and on the Z-axis negative direction side, respectively. The seal groove 303 has an annular shape extending in the direction around the central axis of the cylinder 30. The plurality of fluid passages includes the first connection fluid passage 304 and the second connection fluid passage 305 as the simulator connection fluid passage, and the first bleeder fluid passage 307A and the second bleeder fluid passage 307B. The plurality of ports includes the simulator first connection port 306A and the simulator second connection port 306B as the simulator connection port, the first bleeder port 308A and the second bleeder port 308B.

The simulator first connection port 306A has a cylindrical shape extending in the Y-axis direction inside the first fluid passage portion 361, and is opened on the surface 381. The first connection fluid passage 304 has one end connected (opened) to the Z-axis positive direction side, the X-axis positive direction side, and the Y-axis negative direction side of the small-diameter portion 301, and extends from this one end in the Y-axis negative direction inside the first fluid passage portion 361. The end of the first connection fluid passage 304 in the Y-axis negative direction is connected (opened) to the port 306A. The simulator second connection port 306B has a cylindrical shape extending in the Y-axis direction inside the second fluid passage portion 362, and is opened on the surface 382. The second connection fluid passage 305 has one end connected (opened) to the Z-axis positive direction side, the X-axis positive direction side, and the Y-axis negative direction side of the large-diameter portion 302, and extends from this one end in the Y-axis negative direction inside the second fluid passage portion 362. The end of the second connection fluid passage 305 in the Y-axis negative direction is connected (opened) to the port 306B. The first bleeder portion 308A and the second bleeder portion 308B are configured similarly to the first embodiment. Other configurations of the first unit 1A are similar to the first embodiment.

Next, a configuration of the second unit 1B will be described. The housing 5 of the second unit 1B includes an extension portion 57 extending from the right side surface 506 in the X-axis positive direction. The extension portion 57 is a generally cuboidal block formed integrally with the housing 5 with use of aluminum alloy as a material thereof. The extension portion 57 includes a front surface 571, a back surface 572, a bottom surface 573, a top surface 574, and a right side surface 576. The front surface 571 is a flat surface relatively large in area. The back surface 572 is a flat surface generally in parallel with the front surface 571, and is located opposite (of the housing 5) from the front surface 571. The bottom surface 573 is a flat surface continuous to the front surface 571 and the back surface 572. The top surface 574 is a flat surface generally in parallel with the bottom surface 573, and is located opposite (of the housing 5) from the bottom surface 573. The right side surface 576 is a flat surface generally in parallel with the left side surface 505, and is located opposite (of the housing 5) from the left side surface 505. The right side surface 576 is a flat surface continuous to the front surface 571, the back surface 572, the bottom surface 573, and the top surface 574. The front surface 571 is disposed on the Y-axis positive direction side and extends generally in parallel with the XZ plane with the housing 5 mounted on the vehicle. The back surface 572 is disposed on the Y-axis negative direction side and extends generally in parallel with the XZ plane. The top surface 574 is disposed on the Z-axis positive direction side and extends generally in parallel with the XY plane. The bottom surface 573 is disposed on the Z-axis negative direction side and extends generally in parallel with the XY plane. The right side surface 576 is disposed on the X-axis positive direction side and extends generally in parallel with the YZ plane.

The front surface 571 includes a surface in the same plane that is continuous from the front surface 501 of the housing 5. The front surface 571 includes a recessed portion 57A continuous to the second recessed portion 50B. The recessed portion 57A is exposed (opened) on the front surface 571, the top surface 574, and the right side surface 576. The recessed portion 57A includes a first flat surface portion 577 and a second flat surface portion 578. The first flat surface portion 577 extends approximately perpendicularly to the Y axis and generally in parallel with the XZ plane. The second flat surface portion 578 extends approximately perpendicularly to the Z axis and generally in parallel with the XY plane. The back surface 572 is a surface in the same plane that is continuous from the back surface 572 of the housing 5. The bottom surface 573 is positioned on the Z-axis positive direction side with respect to the bottom surface 503. The top surface 574 is a surface in the same plane that is continuous from the top surface 504 of the housing 5. The unit first connection port 514 has a bottomed cylindrical shape having a central axis extending in the Y-axis direction, and is opened on the first flat surface 577 of the front surface 571. The port 514 is opened slightly on the X-axis positive direction side with respect to a center of the first flat surface 577 in the X-axis direction and on the Z-axis positive direction side. The port 514 is opened slightly on the Z-axis negative direction side with respect to the master cylinder port 511. The unit second connection port 515 has a bottomed cylindrical shape having a central axis extending in the Y-axis direction, and is opened slightly on the X-axis positive direction side with respect to a center of the front surface 571 in the X-axis direction and on the Z-axis negative direction side. The port 515 is opened on the Z-axis negative direction side with respect to the recessed portion 57A, slightly on the Z-axis positive direction side with respect to the central axis O, and slightly on the X-axis positive direction side with respect to the port 514. The bolt holes 565 and 566 for fixing the first unit are each a through-hole having a central axis extending in the Y-axis direction, and are opened on the front surface 571 and the back surface 572. The first hole 565 is opened on an X-axis positive direction side and a Z-axis positive direction side of the first flat surface 577. The first hole 565 is opened on the X-axis positive direction side and the Z-axis positive direction side with respect to the first connection port 514 as viewed from the Y-axis direction. The second hole 566 is opened on an X-axis negative direction side and a Z-axis negative direction side of the front surface 571. The second hole 566 is opened on the X-axis negative direction side and the Z-axis negative direction side of the unit second connection port 515 as viewed from the Y-axis direction.

The surfaces 381 to 383 of the housing 3 are in abutment with the front surface 571 of the extension portion 57. As viewed from the Y-axis direction (the axial direction of the connection port 306), the unit first connection port 514 and the simulator first connection port 306A overlap each other, and the unit second connection port 515 and the simulator second connection port 306B overlap each other in such a state that the central axis of the bolt hole 391 of the first flange portion 351 and the central axis of the bolt hole 565 of the housing 5 are generally in alignment with each other and the central axis of the bolt hole 392 of the second flange portion 352 and the central axis of the bolt hole 566 of the housing 5 are generally in alignment with each other. Due to the overlap of the former pair, the port 306A is connected to the positive pressure fluid passage 16 (the port 514) opened on the outer surface of the housing 5. Due to the overlap of the latter pair, the port 306B is connected to the back-pressure fluid passage 17 (the port 515) opened on the outer surface of the housing 5. In this state, the housing 3 is fixed to the front surface 571 of the extension portion 57. The first and second flange portions 351 and 352 are fixed to the housing 5 with use of the bolts b3, respectively. The head portions of the bolts b3 are disposed on the back surface 572 side of the extension portion 57. The shaft portions of the bolts b3 penetrate through the bolt holes 565 and 566 for fixing the first unit, and the male screws on the distal end sides of the shaft portions are threadably engaged with the female screws of the bolt holes 391 and 392 of the housing 3. The flange portions 351 and 352 are fixedly fastened to the front side surface 571 between the head portions of the bolts b3 and the front surface 571 of the extension portion 57 due to the axial forces of the bolts b3. The bolt holes 391 and 392 function as the fixation portion for fixing the first unit 1A (the housing 3) to the second unit 1B (the housing 5). A leak of the brake fluid outward from the opening portion of the port 306, 514, or 515 via a space between the surface 381 or 382 and the front surface 571 is prevented or reduced with the aid of a close contact between each of the surfaces 381 and 382, and 571 due to the axial forces of the bolts b2. The first flange portion 351 is provided integrally with the fluid passage portions 361 and 362. Therefore, fixing the first flange portion 351 to the housing 5 can more efficiently strengthen the connections between the ports 306A and 306B and the ports 514 and 515. Further, the second flange portion 352 is provided at the position of the housing 3 (the stroke simulator 4) axially separated from the first flange portion 351. Therefore, the axially elongated housing 3 can be attached to the housing 5 with enhanced strength. A space may be generated between the surface 383 of the first flange portion 351 and the front surface 571. Further, a gasket (a seal member) may be provided between the surface(s) 381 and/or 382 and the front surface 571. For example, an O-ring may be set on the surface 381 or 382 or the front surface 571 so as to surround the opening portion of the port 306, 514, or 515. Alternatively, a sheet-like gasket may be disposed between the surface 381 or 382 and the front surface 571. A member disposed therebetween is not limited to the gasket, and a member including a fluid passage connecting the ports 306 and 514 (515) to each other may be disposed therebetween.

Next, advantageous effects will be described. The first connection fluid passage 304 extends on approximately the same straight line as the first bleeder fluid passage 307A. Therefore, the brake system 1 allows both the fluid passages 304 and 307A to be formed by the same processing process, and therefore can improve productivity. Similarly, the second connection fluid passage 305 extends on approximately the same straight line as the second bleeder fluid passage 307B, and therefore the brake system 1 can improve the productivity.

### Other Embodiments

Having described the embodiments for implementing the present invention with reference to the drawings, the specific configuration of the present invention is not limited to the embodiments, and the present invention includes even a design modification and the like thereof made within a range that does not depart from the spirit of the present invention, if any. For example, the specific shapes of the housings 3 and 5 are not limited to the examples in the embodiments. The specific structure of the stroke simulator 4 (the number of springs and a layout of the damper and the like) is not limited to the example in the embodiments.

In the following description, technical ideas recognizable from the above-described embodiments will be described.

A hydraulics control apparatus, in one configuration thereof, includes a hydraulic unit and a stroke simulator unit. The hydraulic unit includes a housing including a brake fluid passage therein, a unit connection fluid passage having one end side connected to the brake fluid passage, a unit connection port provided on a surface of the housing and connected to the other end side of the unit connection fluid passage, a hydraulic source provided inside the housing and configured to generate a hydraulic pressure in a wheel cylinder of a vehicle via the brake fluid passage, and a motor attached to a surface of the housing and configured to actuate the hydraulic source. The stroke simulator unit includes a stroke simulator. The stroke simulator is provided as a different unit from a master cylinder configured to generate the hydraulic pressure according to a brake pedal operation. The stroke simulator is disposed in such a manner that an actuation axis direction thereof coincides with a longitudinal direction of a side surface with respect to a motor attachment surface of the housing. The stroke simulator is configured to generate a reaction force of the brake pedal operation. The stroke simulator unit further includes a simulator connection fluid passage having one end side connected to the stroke simulator, and a simulator connection port. The simulator connection port is provided on the other end side of the simulator connection fluid passage. The simulator connection port is connected to the unit connection port. The simulator connection port overlaps the unit connection port as viewed from an axial direction of the unit connection port.

According to a further preferable configuration, in the above-described configuration, the unit connection port is provided on the side surface with respect to the motor attachment surface of the housing.

According to another preferable configuration, in the above-described configurations, when a back surface is assumed to be a surface of the housing opposite from the motor attachment surface, the stroke simulator is disposed on a side of the motor attachment surface opposite from the back surface in a rotational axis direction of the motor.

According to further another preferable configuration, the stroke simulator is disposed so as to overlap the motor attachment surface when being viewed from the rotational axis direction of the motor.

According to further another preferable configuration, in the above-described configurations, the stroke simulator is disposed between the motor attachment surface and an end surface of the motor opposite from the motor attachment surface in the rotational axis direction of the motor.

According to further another preferable configuration, the stroke simulator unit is disposed at the motor attachment surface side with respect to the end surface of the motor opposite from the motor attachment surface in the rotational axis direction of the motor.

According to further another preferable configuration, in the above-described configurations, surfaces of the housing include a first surface on which the motor is attached, a second surface located opposite of the housing from the first surface on which a control unit for driving the motor is disposed, a third surface provided continuously to the first surface and the second surface on which a wheel cylinder connection port is disposed with the wheel cylinder connection port connected to a pipe leading to the wheel cylinder, and a fourth surface provided continuously to the first surface, the second surface, and the third surface, on which the unit connection port is disposed.

According to further another preferable configuration, in the above-described configurations, the stroke simulator is disposed on an opposite side of the first surface from the second surface in the rotational axis direction of the motor.

According to further another preferable configuration, in the above-described configurations, the stroke simulator is disposed so as to overlap the first surface when being viewed from the rotational axis direction of the motor.

According to further another preferable configuration, in the above-described configurations, the stroke simulator is disposed between the first surface and an end surface of the motor opposite from the first surface in the rotational axis direction of the motor.

According to further another preferable configuration, in the above-described configurations, the stroke simulator unit is disposed on the first surface side with respect to the end surface of the motor opposite from the first surface in the rotational axis direction of the motor.

According to further another preferable configuration, in the above-described configurations, the surfaces of the housing include a fifth surface located opposite of the housing from the fourth surface and facing a connector for electrically connecting the control unit to an external device.

According to further another preferable configuration, in the above-described configurations, the surfaces of the housing include a sixth surface located opposite of the housing from the third surface on which a hole for fixing the housing to a vehicle body side of the vehicle is opened.

According to further another preferable configuration, in the above-described configurations, the stroke simulator includes a piston defining a first chamber and a second chamber in a cylinder. A plug forming the second chamber together with the cylinder and the piston is provided in the actuation axis direction of the stroke simulator and on the sixth surface side.

According to further another preferable configuration, the stroke simulator includes a piston defining a first chamber and a second chamber in a cylinder, a first bleeder valve provided in the first chamber, and a second bleeder valve provided in the second chamber. The first bleeder valve and the second bleeder valve are disposed in a rotational axis direction of the motor toward the motor attachment surface side with respect to the cylinder.

Further, from another aspect, a hydraulics control apparatus includes a housing including a brake fluid passage therein, a hydraulic source provided inside the housing and configured to generate a hydraulic pressure in a wheel cylinder via the brake fluid passage, a motor attached to the housing and configured to actuate the hydraulic source, and a stroke simulator. The stroke simulator is provided as a different unit from a master cylinder configured to generate the hydraulic pressure according to a brake pedal operation. The stroke simulator is disposed in such a manner that an actuation axis direction thereof coincides with a longitudinal direction of a side surface with respect to a motor attachment surface of the housing. The stroke simulator is configured to generate a reaction force of the brake pedal operation.

According to further preferable configuration, in the above-described configuration, when a back surface is assumed to be a surface of the housing opposite from the motor attachment surface, the stroke simulator is disposed on a side of the motor attachment surface opposite from the back surface in a rotational axis direction of the motor.

According to further preferable configuration, in the above-described configurations, the stroke simulator is disposed so as to overlap the motor attachment surface when being viewed from the rotational axis direction of the motor.

According to further preferable configuration, in the above-described configurations, the stroke simulator is disposed between the motor attachment surface and an end surface of the motor opposite from the motor attachment surface in the rotational axis direction of the motor.

From further another aspect, a brake system includes a hydraulic unit, a stroke simulator unit, and a master cylinder unit. The hydraulic unit includes a housing including a brake fluid passage therein, a unit connection fluid passage having one end side connected to the brake fluid passage, a unit connection port provided on a surface of the housing and connected to the other end side of the unit connection fluid passage, a hydraulic source provided inside the housing and configured to generate a hydraulic pressure in a wheel cylinder of a vehicle via the brake fluid passage, and a motor attached to a surface of the housing and configured to actuate the hydraulic source. The stroke simulator unit includes a stroke simulator. The stroke simulator is provided as a different unit from a master cylinder configured to generate the hydraulic pressure according to a brake pedal operation. The stroke simulator is disposed in such a manner that an actuation axis direction thereof coincides with a longitudinal direction of a side surface with respect to a motor attachment surface of the housing. The stroke simulator is configured to generate a reaction force of the brake pedal operation. The stroke simulator unit further includes a simulator connection fluid passage having one end side connected to the stroke simulator, and a simulator connection port. The simulator connection port is provided on the other end side of the simulator connection fluid passage. The simulator connection port is connected to the unit connection port. The simulator connection port overlaps the unit connection port as viewed from an axial direction of the unit connection port. The master cylinder unit is attached to the hydraulic unit, and includes the master cylinder configured to generate the hydraulic pressure according to the brake pedal operation.

Having described merely several embodiments of the present invention, it is apparent to those skilled in the art that the embodiments described as the examples can be modified or improved in various manners without substantially departing from the novel teachings and advantages of the present invention. Therefore, such a modified or improved embodiment is intended to be also contained in the technical scope of the present invention. The features of the above-described embodiments may also be arbitrarily combined.

The present application claims priority under the Paris Convention to Japanese Patent Application No. 2016-120920 filed on Jun. 17, 2016. The entire disclosure of Japanese Patent Application No. 2016-120920 filed on Jun. 17, 2016 including the specification, the claims, the drawings, and the abstract is incorporated herein by reference in its entirety.

### REFERENCE SIGN LIST

1A first unit (stroke simulator unit)
1B second unit (hydraulic unit)
1C third unit (master cylinder unit)
2 pump (hydraulic source)
4 stroke simulator
5 housing
7 master cylinder
16 positive pressure fluid passage (unit connection fluid passage)
17 back-pressure fluid passage (unit connection fluid passage)
90 ECU (control unit)
20 motor
30 cylinder
41 piston
48 plug member
304 first connection fluid passage (simulator connection fluid passage)
305 second connection fluid passage (simulator connection fluid passage)
306A simulator first connection port (simulator connection port)
306B simulator second connection port (simulator connection port)
401 positive pressure chamber (first chamber)
402 back-pressure chamber (second chamber)
501 front surface (motor attachment surface) (first surface)
502 back surface (second surface)
503 bottom surface (sixth surface)
504 top surface (third surface)
505 left side surface (fifth surface)
506 right side surface (fourth surface)
514 positive pressure port (unit connection port)
515 back-pressure port (unit connection port)
BV1 first bleeder valve
BV2 second bleeder valve

1. A hydraulics control apparatus comprising:
a hydraulic unit; and
a stroke simulator unit,
wherein the hydraulic unit includes
a housing including a brake fluid passage therein,
a unit connection fluid passage having one end side connected to the brake fluid passage,
a unit connection port provided on a surface of the housing and connected to the other end side of the unit connection fluid passage,
a hydraulic source provided inside the housing and configured to generate a hydraulic pressure in a wheel cylinder of a vehicle via the brake fluid passage, and
a motor attached to a surface of the housing and configured to actuate the hydraulic source, and
wherein the stroke simulator unit includes
a stroke simulator provided as a different unit from a master cylinder configured to generate the hydraulic pressure according to a brake pedal operation, the stroke simulator being disposed in such a manner that an actuation axis direction thereof coincides with a longitudinal direction of a side surface of the housing, the side surface of the housing being adjacent to a motor attachment surface, the stroke simulator being configured to generate a reaction force of the brake pedal operation,
a simulator connection fluid passage having one end side connected to the stroke simulator, and
a simulator connection port provided on the other end side of the simulator connection fluid passage, the simulator connection port being connected to the unit connection port, the simulator connection port overlapping the unit connection port as viewed from an axial direction of the unit connection port.

2. The hydraulic control apparatus according to claim 1, wherein the unit connection port is provided on the side surface of the housing, the side surface of the housing being adjacent to a motor attachment surface.

3. The hydraulic control apparatus according to claim 2, wherein, when a back surface is assumed to be a surface of the housing opposite from the motor attachment surface,
the stroke simulator is disposed on a side of the motor attachment surface opposite from the back surface in a rotational axis direction of the motor.

4. The hydraulic control apparatus according to claim 3, wherein the stroke simulator is disposed so as to overlap the motor attachment surface when being viewed from the rotational axis direction of the motor.

5. The hydraulic control apparatus according to claim 4, wherein the stroke simulator is disposed between the motor attachment surface and an end surface of the motor opposite from the motor attachment surface in the rotational axis direction of the motor.

6. The hydraulic control apparatus according to claim 5, wherein the stroke simulator unit is disposed at the motor attachment surface side with respect to the end surface of the motor opposite from the motor attachment surface in the rotational axis direction of the motor.

7. The hydraulic control apparatus according to claim 1, wherein surfaces of the housing include
a first surface on which the motor is attached,
a second surface located opposite of the housing from the first surface, on which a control unit for driving the motor is disposed,
a third surface provided continuously to the first surface and the second surface, on which a wheel cylinder connection port is disposed, the wheel cylinder connection port being connected to a pipe leading to the wheel cylinder, and
a fourth surface provided continuously to the first surface, the second surface, and the third surface, on which the unit connection port is disposed.

8. The hydraulic control apparatus according to claim 7, wherein the stroke simulator is disposed on an opposite side of the first surface from the second surface in the rotational axis direction of the motor.

9. The hydraulic control apparatus according to claim 8, wherein the stroke simulator is disposed so as to overlap the first surface when being viewed from the rotational axis direction of the motor.

10. The hydraulic control apparatus according to claim 9, wherein the stroke simulator is disposed between the first surface and an end surface of the motor opposite from the first surface in the rotational axis direction of the motor.

11. The hydraulic control apparatus according to claim 10, wherein the stroke simulator unit is disposed at the first surface side with respect to the end surface of the motor opposite from the first surface in the rotational axis direction of the motor.

12. The hydraulic control apparatus according to claim 7, wherein the surfaces of the housing include a fifth surface located opposite of the housing from the fourth surface and facing a connector for electrically connecting the control unit to an external device.

13. The hydraulic control apparatus according to claim 12, wherein the surfaces of the housing include a sixth surface located opposite of the housing from the third surface, on which a hole for fixing the housing to a vehicle body side of the vehicle is opened.

14. The hydraulic control apparatus according to claim 13, wherein the stroke simulator includes a piston defining a first chamber and a second chamber in a cylinder, and
wherein a plug forming the second chamber together with the cylinder and the piston is provided in the actuation axis direction of the stroke simulator and at the sixth surface side.

15. The hydraulic control apparatus according to claim 1, wherein the stroke simulator includes
a piston defining a first chamber and a second chamber in a cylinder,
a first bleeder valve provided in the first chamber, and
a second bleeder valve provided in the second chamber, and
wherein the first bleeder valve and the second bleeder valve are disposed in a rotational axis direction of the motor toward the motor attachment surface side with respect to the cylinder.

16. A hydraulics control apparatus comprising:
a housing including a brake fluid passage therein;
a hydraulic source provided inside the housing and configured to generate a hydraulic pressure in a wheel cylinder via the brake fluid passage;
a motor attached to the housing and configured to actuate the hydraulic source; and
a stroke simulator provided as a different unit from a master cylinder configured to generate the hydraulic pressure according to a brake pedal operation, the stroke simulator being disposed in such a manner that an actuation axis direction thereof coincides with a longitudinal direction of a side surface with respect to a motor attachment surface of the housing, the stroke simulator being configured to generate a reaction force of the brake pedal operation.

17. The hydraulic control apparatus according to claim 16, wherein, when a back surface is assumed to be a surface of the housing opposite from the motor attachment surface, the stroke simulator is disposed on a side of the motor attachment surface opposite from the back surface in a rotational axis direction of the motor.

18. The hydraulic control apparatus according to claim 17, wherein the stroke simulator is disposed so as to overlap the motor attachment surface when being viewed from the rotational axis direction of the motor.

19. The hydraulic control apparatus according to claim 18, wherein the stroke simulator is disposed between the motor attachment surface and an end surface of the motor opposite from the motor attachment surface in the rotational axis direction of the motor.

20. A brake system comprising:
a hydraulic unit; and
a stroke simulator unit,
wherein the hydraulic unit includes
a housing including a brake fluid passage therein,
a unit connection fluid passage having one end side connected to the brake fluid passage,
a unit connection port provided on a surface of the housing and connected to the other end side of the unit connection fluid passage,
a hydraulic source provided inside the housing and configured to generate a hydraulic pressure in a wheel cylinder of a vehicle via the brake fluid passage, and
a motor attached to a surface of the housing and configured to actuate the hydraulic source,
wherein the stroke simulator unit includes
a stroke simulator provided as a different unit from a master cylinder configured to generate the hydraulic pressure according to a brake pedal operation, the stroke simulator being disposed in such a manner that an actuation axis direction thereof coincides with a longitudinal direction of a side surface with respect to a motor attachment surface of the housing, the stroke simulator being configured to generate a reaction force of the brake pedal operation,
a simulator connection fluid passage having one end side connected to the stroke simulator, and
a simulator connection port provided on the other end side of the simulator connection fluid passage, the simulator connection port being connected to the unit connection port, the simulator connection port overlapping the unit connection port as viewed from an axial direction of the unit connection port, and
wherein the brake system further includes a master cylinder unit, the master cylinder unit being attached to the hydraulic unit and including the master cylinder configured to generate the hydraulic pressure according to the brake pedal operation.
